(19) United States
(12) Patent Application Publication
(10) Pub. No.: US 2010/0128367 A1
(43) Pub. Date: May 27, 2010

(54) PROJECTION OBJECTIVE FOR A MICROLITHOGRAPHY APPARATUS AND METHOD

(75) Inventors: Mariella Beckenbach, Heilbronn (DE); Klaus Rief, Aalen-Oberalfingen (DE); Andreas Bertele, Koenigsbronn (DE); Benjamin Sigel, Aalen (DE); Sascha Bleidistel, Aalen (DE); Wolfgang Hummel, Aalen (DE); Andreas Frommeyer, Schwaebisch Gmuend (DE); Toralf Gruner, Aalen-Hofen (DE); Jochen Schwaer, Aalen (DE); Baerbel Schwaer, Aalen (DE); Thomas Schletterer, Stadtroda (DE); Artur Hoegele, Oberkochen (DE); Armin Schoeppach, Aalen (DE)

Correspondence Address: FISH & RICHARDSON PC, P.O. BOX 1022, MINNEAPOLIS, MN, 55440-1022, US

(73) Assignee: CARL ZEISS SMT AG, Oberkochen (DE)

(21) Appl. No.: 12/403,526

(22) Filed: Mar. 13, 2009

Related U.S. Application Data
(63) Continuation of application No. PCT/EP07/08476, filed on Sep. 28, 2007.
(60) Provisional application No. 60/847,814, filed on Sep. 28, 2006.

(30) Foreign Application Priority Data
Sep. 28, 2006 (DE) 102006047666.2

(51) Int. Cl. G02B 7/02

(52) U.S. Cl. 359/820; 359/822

(57) ABSTRACT

A projection objective for a microlithography apparatus with improved imaging properties is provided. A manipulator for a projection objective is provided. A microlithography apparatus including a projection objective of this type and/or a manipulator of this type is provided. A method for improving the imaging properties of a projection objective is provided.

### CROSS-REFERENCE TO RELATED APPLICATIONS

This application is a continuation of, and claims benefit under 35 USC 120 to, international application PCT/EP2007/008476, filed Sep. 28, 2007, which claims benefit of German Application No. 10 2006 047 666.2, filed Sep. 28, 2006 and U.S. Ser. No. 60/847,814, filed Sep. 28, 2006. International application PCT/EP2007/008476 is hereby incorporated by reference.

### FIELD

The disclosure relates to a projection objective for a microlithography apparatus with improved imaging properties. The disclosure furthermore relates to a manipulator for a projection objective. The disclosure furthermore relates to a microlithography apparatus including a projection objective of this type and/or a manipulator of this type. The disclosure additionally relates to a method for improving the imaging properties of a projection objective.

### BACKGROUND

A projection objective of the is often situated in the illumination system of a microlithography apparatus, where a field to be illuminated is imaged into a plane in which a reticle is situated, or said projection objective is situated in the projection system of a microlithography apparatus, where a reticle to be illuminated is imaged into a plane in which a wafer is situated. The term “projection objective” should therefore be understood for both of the aforementioned cases in the context of the present disclosure. For reasons of simplicity, the present disclosure is described on the basis of the example of a projection objective via which a reticle is imaged onto a wafer. Projection objectives are used in microlithography apparatuses during lithographic methods for producing for example semiconductor components, image sensor elements, displays and the like. Projection objectives are generally used for the lithographic production of finely structured components. A projection objective is typically constructed from a plurality of optical elements, which can all be lenses. The projection objective can also be constructed from a combination of lenses and mirrors.

Via the projection objective, a structure or a pattern of a mask (reticle) which is arranged for example in the object plane of the projection objective is imaged on a light-sensitive substrate arranged in the image plane of the projection objective. The structures or patterns to be imaged are becoming ever smaller in order to increase the integration density of the components to be produced, such that increasingly more stringent desired properties that are being made of the resolution capability and the imaging properties, in particular the imaging quality, of present-day projection objectives.

The imaging quality of a projection objective can be impaired by aberrations. Such aberrations can be diverse in nature. Thus, before such a projection objective has actually been put into operation for the first time, aberrations can be caused inherently on account of inadequate material specifications or fabrication or assembly inaccuracies.

Such inherent aberrations can largely be eliminated, however, during fabrication of the individual optical elements of the objective and during the assembly process, in particular individual lenses of a projection objective being provided with aspherical surfaces for this purpose.

However, aberrations can also arise after the projection objective has been put into operation or during the operation of the projection objective or in the course of the ageing of the projection objective. The cause of such aberrations can be found in radiation-dependent alterations in the optical material of the optical elements of the optical projection objective.

The radiation-dependent alterations can be permanent, such as, for example, a compaction of the material of the optical elements, or they can be only temporary. Temporary alterations in the optical material of the optical elements of the projection objective are predominantly based on the fact that the individual optical elements are heated during exposure operation and are thereby deformed or the refractive index changes as a result. In modern microlithography apparatuses, in particular, high radiation powers are used in order to obtain a high productivity, that is to say high number of irradiated semiconductor substrates per unit time.

What is characteristic of radiation-dependent material alterations which lead to aberrations is that the second-order or two-fold symmetry of the rectangular field of the illumination slot and of the image field is transferred to the aberrations.

This breaking of the rotational symmetry of the projection objective leads to typical image aberrations which are generally difficult to correct.

Image aberrations which are likewise difficult to correct are established if, in addition to the two-fold symmetry of the rectangular field, the latter is not symmetrical with respect to an optical axis of the projection objective and, in particular, does not contain a point of traverse of an optical axis.

Typical aberrations caused by heating of the material of the optical elements, which leads to refractive index change or surface change, or caused by density changes (compaction), which can lead to wavefront aberrations by way of refractive index change, are for example a field-constant astigmatism, a field-constant third-order aberration or a field-constant fourth-order aberration.

Besides field-constant aberrations, however, aberrations also occur which exhibit a field dependence or a field profile, for example a first-order field profile of the distortion (anamorphism) and an astigmatic field profile of the image shell.

It is known that a field-constant astigmatism can be corrected via the astigmatic deformation of a lens.

### SUMMARY

The present disclosure provides an optical system of the type mentioned in the introduction in which aberrations that occur, that is to say image aberrations, for instance as a result of material heating and/or material ageing, can be corrected or minimized using a simple mechanism. In this case, the image aberrations mentioned are intended to be able to be corrected or at least significantly reduced by lens astigmatisms produced in a targeted manner.

The present disclosure provides a projection objective with improved imaging properties.

The present disclosure provides a manipulator.

The present disclosure provides a microlithography apparatus having a projection objective with improved imaging properties.

The present disclosure provides a method which improves the imaging properties of the projection objective, optionally which one or more imaging aberrations can be eliminated or at least significantly reduced, optionally those imaging aberrations which are brought about on account of material ageing and/or temporary material heating.

In some embodiments, the disclosure provides a projection objective for microlithography which has a plurality of lenses which in each case have a local optical axis, wherein a first manipulator with a first actuator and at least one second actuator is assigned to at least one first lens from the plurality of lenses, and wherein a first force input and/or moment input can be realized by the first actuator and a second force input and/or moment input can be realized by the second actuator, wherein the first force input and/or moment input and the second force input and/or moment input differ with regard to at least one of the parameters: intensity of the force and/or moment input, direction of the force input relative to the local optical axis, direction of the moment input relative to a periphery of the first lens, such that different ratios of waviness of the lowest radial order to the next higher radial order on at least one surface of the first lens can be generated.

The term “waviness” generally includes radial and azimuthal waviness as well, the latter being equivalently denoted as n-fold symmetry. Waviness of radial orders mentioned before is the radial waviness.

A complex deformation of the first lens can be realized by the different force inputs and/or moment inputs. In this case, it is advantageous that by different types of forces and/or moments at a single lens, here the first lens from a plurality of lenses, complex deformations can be induced which are expediently chosen such that the optical effect of the relevant deformation can precisely compensate for a disturbance, in particular an aberration, such as has been effected for example on account of thermal heating.

In this case, in particular the direction of the force input relative to the local optical axis of the first and second force input differs. The direction vector of the force input can form an angle of between 0 and 180° with the local optical axis of the optical element. In order to realize two different force inputs, the angle of the first and of the second force input differ. A force input parallel to the optical axis is in this case described both with the angle of 0° and with the angle of 180°.

The first and/or the second actuator can be realized as finely threaded pins or as piezo-electric adjusting elements.

Further examples of actuators that can be used here are pneumatic/hydraulic bellows, linear motors, electric motors, etc.

Deformations of the surface of an optical element, that is to say of a lens, can be described by orthogonal function systems, specifically the so-called Zernike polynomials. In this case, Zernike polynomials describe wavefront aberrations for circular apertures.

They represent a complete description of the deformation of the surface of a lens at which arbitrary wavefront aberrations can extend to a discrete shape with a defined size.

Consequently, wavefront aberrations can be classified and the surface deformations can be described quantitatively.

The arrangement of two actuators opposite one another at the periphery of the lens optionally corrects astigmatism, which is described by the Zernike polynomial having the number 5, that is to say Z5. Such an astigmatism is dependent on the angle θ of the polar coordinates and quadratically on the radius. A saddle-like deformation of the lens is involved in this case since forces are exerted on the lens at two locations.

It can be determined from finite element calculations (FEM calculations) that, if a lens geometry has been selected, with the input of different forces and/or moments it is possible to generate different ratios of waviness of the lowest radial order (e.g. Z5, Z6, Z10, Z11, . . . ) to the next higher radial order (e.g. Z12, Z13, Z19, Z20, . . . ) on a surface of the lens.

In a first configuration of the projection objective, the first force input can be implemented parallel to the local optical axis of the first lens.

In this case, the forces act perpendicular to a surface of the lens. This can involve both the image-side surface of the first lens and the object-side surface of the first lens.

In a further configuration of the disclosure, the second force input is effected perpendicular to the local optical axis.

In this case, the forces occur parallel to the surface of the first lens. The actuators can be arranged for example at the periphery of the lens and thus realize the desired force input at the respective positions of the actuators and thus lead to the deformation.

In a further configuration of the disclosure, the first moment input is effected tangentially with respect to a periphery of the first lens.

Tangential moments can realize deformations of the first lens which are different from those realized by forces which are input into the lens perpendicular or parallel to the local optical axis of said lens.

In a further configuration of the disclosure, the second moment input can be realized radially.

Radial moments are advantageously introduced at the periphery of the lens. Complex deformations of the first lens can advantageously be realized by the combination of moments which are introduced radially or tangentially with respect to the first lens and/or the introduction of forces which are directed both perpendicular and parallel to the local optical axis of the first lens. In this case, by way of example, at the first actuator a force is realized perpendicular to the local optical axis of the first lens, and at the second actuator a moment is realized tangentially with respect to the periphery of the first lens.

Different ratios of the low and the higher orders can be realized in this way. By way of example, axial forces can generate a ratio of Z5/Z12 which is different from that generated by tangential moments.

In a further configuration of the disclosure, the first actuator and the second actuator are arranged peripherally at the first lens and in a manner offset by 180°.

Consequently, the first actuator and the second actuator are diametrically opposite one another, wherein the first actuator experiences a force and/or moment input that is different from that of the second actuator.

As a result, symmetrical deformations of the lens can be obtained in a simple manner. Consequently, aberrations distributed symmetrically over the area of the lens, for example astigmatism and/or coma, can be corrected in a targeted manner by the deformation of the lens.

In a further configuration of the disclosure, a third actuator is provided, which is arranged peripherally at the first lens.

An additional force and/or moment input onto the first lens can be effected by the third actuator. Consequently, a deformation of higher complexity can be realized. In this case, the input of forces and/or moments can be effected either perpendicular or parallel to the local axis of the lens, and/or a moment input can be tangential or radial. What is important in this case is that at least two different types of forces and/or moments are transmitted to the lens by the three actuators.

In a further configuration of the disclosure, a fourth actuator is provided, which is arranged peripherally at the first lens.

Four actuators permit a higher complexity of the deformation. The input of different or various forces and/or moments makes it possible to produce a waviness on the surface of the lens which realizes both low radial orders and higher radial orders. In this case, the forces can be oriented substantially perpendicular and/or parallel to the local optical axis of the lens and/or the moments can be introduced tangentially and/or radially. Complex deformations of the lens can be realized if at least two different types of forces and/or moments of the above-mentioned type are realized.

In a further configuration of the disclosure, the third actuator and the fourth actuator are arranged in a manner offset by 180°.

Consequently, the third and the fourth actuator are diametrically opposite one another, and so are the respective force and/or moment input.

In a further configuration of the disclosure, further actuators are provided, which are in each case arranged peripherally at the first lens, wherein the actuators realize at least two different force inputs and/or moment inputs, and wherein the forces are selected from a group of forces including forces which are oriented substantially parallel and/or perpendicular to the local optical axis of the first lens, and/or the moment inputs are selected from a group of moments including radial and/or tangential moments.

In this way, a complex deformation of the first lens is realized by the actuators.

The plane of the lens is defined with three actuators each oriented parallel to the local optical axis of the lens. By introducing forces at three actuators, the lens can be positioned in the Z position, that is to say along the local optical axis, and also in two tilting axes. By the introduction of further actuators, this mechanically unambiguously determined principle is extended by one, and the lens can be deformed in wavy fashion.

Consequently, with this principle it is possible to produce second- or higher-order aberrations, and also a linear combination thereof, in a targeted manner on a lens. This is advantageous in comparison with the use of two actuators, in the case of which only a second-order aberration with a fixed orientation can be realized.

Consequently, actuators each having two actuator elements are provided. Four or more actuators are optionally provided, and higher-order astigmatisms can be corrected with such an arrangement. An aberration described by the Zernike polynomials Z5 and Z10 is optionally corrected. In this case, it is advantageous that the individual actuators can be driven independently of one another.

Furthermore, it should additionally be noted that the arrangement of the respective actuators is provided at the outer periphery of the lens, wherein the first actuator element is arranged in each case above the lens, and the second actuator element is arranged below the lens. The position of the actuator elements can be chosen freely within certain limits as long as a deformation of the lens is obtained. By way of example, a compensation of astigmatisms of different radial waviness can be achieved in this way.

Optionally higher-order aberrations, such as those where n=2, n=3, n=4, can thereby be corrected by deformation of the lens.

Depending on how many actuators the manipulator has, it is possible to produce one-fold (first-order), two-fold (second-order), three-fold (third-order) or generally n-fold (nth-order) deformations or flexures in order to at least partly correct correspondingly first-order, second-order, third-order or generally nth-order aberrations by deformation of the actively deformable lens.

The arrangement of the actuators is chosen in such a way that in each case two actuators are diametrically opposite one another. In the simplest configuration, two actuators are provided which generate forces in the same direction and therefore obtain a deformation/flexure of the lens at two diametrically disposed locations.

Respectively adjacent actuators generate forces in the opposite direction, such that the n-fold deformation or flexure of the lens can thereby be produced.

Forces in an axial direction, that is to say parallel to the optical axis of the first lens, are advantageous since they introduce in a targeted manner the bending of the lens at the location at which the actuator is arranged. The prior art describes active lenses in the case of which only compressive forces are generated, resulting only in an asymmetrical change in thickness. Consequently, the image aberrations resulting from the temperature distribution and/or compaction can be corrected simply and reliably by the axially introduced forces. In particular, it is possible to correct low-order image aberrations, but also higher-order image aberrations.

It is likewise possible for image aberrations resulting from manufacturing faults to be corrected by the projection objective according to the disclosure. The individual lenses can be overcompensated, for example, that is to say that deformations resulting from the temperature input can be deliberately made asymmetrical in another direction. In this way, this results overall in a compensation of the entire projection objective and thus of the exposure apparatus.

Therefore, the projection objective according to the disclosure can be used particularly advantageously in microlithography since image aberrations that occur, in the case of the increasing miniaturization of the structures to be imaged, have particularly serious effects on the accuracy of the mask and therefore is desirably minimized. The compaction effects mentioned in the introduction, which occur as a result of material ageing, can likewise be advantageously corrected in a targeted manner by the deformation of the lens and the axial input of the forces.

Depending on how many actuators are arranged at the periphery of the lens, it is possible to realize and to influence the type of complex deformation.

It should be emphasized at this point that the abovementioned actuators can be applied not only to lenses but also to mirrors, wherein the application of forces and/or moments at the edge of a mirror represents one possibility of manipulating the mirror. The manipulation can of course be possible only on the rear side of the mirror.

It should be assumed that the forces and/or moments can be transmitted from the actuator to the lens either directly or else with the aid of an inner ring or with lever geometries.

In a further configuration of the disclosure, each of the actuators of the manipulator of the first lens has a dedicated open-loop and/or closed-loop control circuit.

As a result, each actuator can be driven separately, and an asymmetrical deformation of the lens can be realized. A tilting of the lens can also be realized. The tilting of the lens is desired when, on account of unpredicted tiltings of the lens, these have to be corrected.

In this case, each actuator can be assigned a dedicated open-loop and/or closed-loop control unit which drives the respective actuator. Consequently, the magnitude, that is to say the size, of the force and/or moment input and the direction thereof relative to the optical axis of the lens can be set separately for each actuator and can also be subjected to open-loop and/or closed-loop control.

However, it is also possible to provide an open-loop and/or closed-loop control unit for driving and controlling all the actuators and to assign a dedicated open-loop and/or closed-loop control circuit in the open-loop and/or closed-loop control unit to each actuator.

Furthermore, it is also possible that the actuators can be driven in pairs or in larger assemblages. This is made possible by interconnecting the open-loop and closed-loop control circuits of a plurality of actuators, in particular in pairs. In the simplest case, a plurality of actuators can then be driven by the same open-loop and/or closed-loop control circuit if they are intended to realize the same force and/or moment inputs. A different group of actuators can be subjected to open-loop and closed-loop control by a different open-loop and closed-loop control circuit.

In a further embodiment of the disclosure, an aberration of the projection objective due to thermal heating of at least one of the lenses from the plurality of lenses can be compensated for by the complex deformation of the first lens.

Since the overall system is heated during the operation of a projection objective, in particular through the use of powerful lasers as illumination source for the mask, this leads to a heating and hence to a deformation/refractive index change of individual lenses in the projection objective.

Therefore, it is desired for the deformation that is effected during operation to be corrected also during operation. This is possible by using actuators by which a complex deformation of the first lens can be realized. Optionally, the complex deformation of the lens is chosen in such a way that the deformations of the lens due to heating are precisely compensated for.

In a further configuration of the disclosure, each actuator has a first actuator element and a second actuator element.

The first actuator and the at least second actuator of the first manipulator of the first lens permit the first lens to be deformed at at least two locations by the input of forces. In general, this deformation can be obtained by a bending of the lens, wherein the size of the bending is in this case chosen in such a way that the image aberrations which occur as a result of the abovementioned material heating or compaction are largely compensated for.

With the actuators according to the disclosure, the lens can be deformed in a targeted manner by a few hundred nanometres to micrometres.

By virtue of the fact that the first actuator is arranged at a first location, optionally at the periphery of the lens, and the second actuator is arranged at a second location, forces which realize the deformation of the lens can be exerted on the lens at two locations at the periphery of the lens, wherein the forces can optionally be compressive or tensile forces. It is also conceivable for torsion forces to be transmitted to the lens and to obtain the deformation in this way. In this case, besides the force and/or moment input, the type of the lens also determines the deformation.

A first actuator element and a second actuator element of the respective actuator permit forces to be transmitted to the lens to one location of the periphery of the lens, but at two differently arranged points with respect to the optical axis of the lens.

In a further configuration of the disclosure, the first actuator element is arranged at the first lens on the object side and the second actuator element is arranged at the first lens on the image side.

In this case, it is advantageous that the forces and/or moments can be introduced on both sides of the lens. This ensures a high flexibility.

In a further configuration of the disclosure, forces and/or moments can be introduced into the first lens by the actuators and the actuator elements in a direction parallel and/or perpendicular to the local optical axis and/or moments can be introduced into the first lens in an axial direction and/or tangential direction.

As a result, it is advantageously possible to realize complex deformations of the first lens which compensate for the deformations brought about by thermal effects in the projection objective or by material alterations of the lenses in the projection objective.

In this case, it is advantageous that the type of forces which are transmitted to the lens by the actuator elements can be identical or different in magnitude, irrespective of whether they are exerted by the first actuator element or by the second actuator element. The direction of the force input differs in this case. The first actuator element exerts a force on the lens from above, and the second actuator element from below, that is to say at different points.

By way of example, if the lens is intended to be bent upwards at the location of the actuator, the actuator elements arranged below the lens become active and the actuator elements arranged above the lens are not active; if the lens is intended to be bent downwards, the actuator elements arranged above the lens are active and the actuator elements arranged below the lens are not active. In this case, optionally compressive forces can be exerted by the actuator elements. Consequently, the actuator elements can be designed in a simple manner since they only have to implement one type of forces.

Actuators of a manipulator of a projection objective which each have a first and a second actuator element are also regarded as an independent disclosure, that is to say also without those features of Claim 1 according to which the force input and/or moment input of the at least two actuators of the manipulator differs.

According to another aspect of the present disclosure, which can be combined with the above-described first aspect, but which can also be used without the feature of the first aspect according to which different ratios of waviness of the lowest radial order to the next higher radial order on at least one surface of the lens to be deformed are generated provides a configuration according to which at least one second lens having a local optical axis with a second manipulator is provided, wherein the second manipulator has a first and at least one second actuator, wherein a first force input and/or moment input can be realized by the first actuator and a second force input and/or moment input can be realized by the second actuator, wherein the first force input and/or moment input and the second force input and/or moment input differ.

A complex deformation of the second lens can be realized by the different force inputs and/or moment inputs.

The correction of aberration by a first lens and a second lens is advantageous since low-order image aberrations and higher-order image aberrations can be corrected independently of one another in this way. This is based on the fact that in the case of correction using only one optical element, that is to say one lens, the low and the higher orders of the image aberrations are linearly dependent on one another. An expedient optimization of the correction is possible only with difficulty since, if for example the low order, for example a second-order aberration, is corrected, the higher order, that is to say for example a third-order or fourth-order aberration, in the image aberration is overcompensated.

By a first lens and a second lens, wherein both lenses can be deformed by actuators, there is the possibility of setting the low order and the higher radial orders independently of one another. In this case, it is advantageous that the ratios of radial low order to higher radial order have different signs, but are identical in terms of the magnitude of the force that is input.

In a further configuration of the disclosure, the first force input is effected parallel to a local optical axis of the second lens.

The first force input is thus directed perpendicular to a surface of the second lens. Both the image-side surface and the object-side surface of the second lens can be involved in this case.

In a further configuration of the disclosure, the second force input can be realized perpendicular to the local optical axis.

The force input is thus effected parallel to the surface of the second lens.

In a further configuration of the disclosure, the first moment input can be realized tangentially with respect to a periphery of the second lens.

Tangential moments are for example torques which are input into the lens. It is thereby possible to alter a waviness on the surface of the lens in relation to the other lenses of the projection objective, and thus to contribute to a correction of the aberrations.

In a further configuration of the disclosure, the second moment input can be realized radially.

Radial moments act symmetrically with respect to the local optical axis of the lenses.

In a further configuration, the first and the second actuator are arranged peripherally at the second lens and in a manner offset by 180°.

Consequently, symmetrical deformations can advantageously be realized.

In a further configuration of the disclosure, a third actuator is provided, which is arranged peripherally at the second lens.

The plane of the lens is defined by three actuators, and deformations can be realized at two tilting axes by the input of forces and/or moments at the three actuators.

In a further configuration of the disclosure, a fourth actuator is provided, which is arranged peripherally at the second lens.

In a further configuration of the disclosure, the third actuator and the fourth actuator are arranged in a manner offset by 180°.

Four actuators each arranged in a manner offset by 90° are arranged at the second manipulator, which actuators can therefore realize complex deformations at the second lens.

In a further configuration of the disclosure, further actuators are provided, which are in each case arranged peripherally at the second lens, wherein a complex deformation of the second lenses can be realized by the actuators by at least two different force inputs and/or moment inputs of the actuators.

The complex deformations of the second lens advantageously compensate for the optical effect—the aberrations—produced by a disturbance on account of thermal heating or material alterations on account of ageing of the lens in the projection objective.

In a further configuration of the disclosure, each actuator of the manipulator of the second lens has a dedicated open-loop and/or closed-loop control circuit, such that each actuator can be driven separately.

As a result, it is advantageously possible to realize asymmetrical deformations of the second lens. If, by way of example, two actuators are arranged peripherally at the second lens, a tilting can be realized by each actuator being driven separately. For this purpose, each actuator is assigned a dedicated open-loop and/or closed-loop control circuit in an open-loop and closed-loop control unit. In this case, all the actuators can be assigned to one open-loop and closed-loop control unit having a respective subunit, such that each actuator is assigned to a dedicated open-loop and/or closed-loop control circuit.

In a further configuration of the disclosure, each actuator has a first actuator element and a second actuator element, wherein the first actuator element is arranged on the image side at the first lens and/or second lens and the second actuator element is arranged on the object side with respect to the first lens and/or second lens.

By this means it is possible, both at the first lens and at the second lens, to introduce forces and/or moments from the image-side surface of the first lens and/or the second lens and/or the object-side surface of one of the two lenses. The possibilities for realizing complex deformations are therefore highly diverse.

This means that different actuator elements are active in each case. By way of example, if a force input having a positive sign is intended to be obtained, the upper actuator element becomes active, and a force, directed downwards onto the lens at this location, results therefrom; if a negative sign is desired, the second, that is to say lower, actuator element becomes active, and an upwardly directed force results therefrom. Consequently, it is also particularly advantageous that both negative lenses and positive lenses (diverging lenses and converging lenses) can be corrected. In this case, it should be emphasized that lenses at different positions in the projection objective produce different corrections of the aberrations. Optically conjugate or non-conjugate positions can be involved in this case.

In a further configuration, it is provided that an aberration of the projection objective as a result of thermal heating and/or material alteration of one of the lenses from the plurality of lenses can be compensated for by the deformation of the first lens and/or the second lens.

In this case it is advantageous that the image aberrations can be corrected for the second lens, too, with higher orders since higher orders of the deformation can also be produced by a plurality of actuators.

In a further configuration of the disclosure, each actuator element can be moved pneumatically.

Pneumatic driving is advantageous since this involves a simple mechanical principle which does not require a guide and is therefore largely free of friction and wear. Furthermore, the actuator elements can be adjusted with a high adjusting speed.

In a further configuration of the disclosure, each actuator element can be moved hydraulically, mechanically and/or electrically and/or magnetically.

Hydraulic movement elements are widespread and therefore cost-effective and available in large numbers.

Mechanical movement elements are available by lever constructions, for example, and have a high flexibility with regard to the geometrical arrangement of moveable parts. Electrical devices for moving actuators can be realized in a mechanically small space. In general, such drives have a gearing, e.g. a linear or lever gearing for stepping-down or stepping-up transmission. Solid-state articulations can advantageously be used in this case. In particular very small movements of the actuator elements can be realized by piezoelectric units.

In a further configuration, the first lens and/or, if appropriate, the second lens from the multiplicity of lenses is mounted by a plurality of holding elements arranged at the periphery of the respective lens and the holding elements can be connected to a carrying ring.

A punctiform mounting of the lens is thus realized. In this case, the number of holding elements determines the number of mounting points of the lens. A larger number of holding elements permits a more complex deformation of the lens than a smaller number of holding points.

The holding elements are connected to the carrying ring, wherein the holding elements and the carrying ring can be designed in one piece.

The carrying ring supplies a common base for the holding elements, wherein the holding elements are connected to the carrying ring in a releasable or non-releasable manner. A releasable connection would have the advantage that individual holding elements can be exchanged.

It is optionally provided that the respective actuators which realize the respective force and/or moment input at the lens are operatively connected to the carrying ring or the respective holding element. In this case, the force and/or moment input onto the lens is in each case realized by the holding elements, which can optionally be moved in the vertical direction.

In this case, it is advantageous that an exact choice of a location of the force and/or moment input is realized by the holding elements.

In a further configuration, at least two contact areas are provided between the lens and each of the holding elements and the contact areas are arranged substantially opposite one another. Optionally, the first lens and/or the second lens from the plurality of lenses is mounted by at least four holding elements, and an axial and a radial position of the lens can be set in this way.

The first lens and/or the second lens can thus be held in a positionally stable manner. The forces for the targeted deformation can be transmitted to the first and/or second lens without a cohesive connection, for example by adhesive-bonding connection, having to be applied. Larger inputs of forces and/or moments can be realized as a result since these are limited in the case of adhesive-bonding connections for example by the relatively low strength of the available adhesives.

Consequently, the mounting of the first and/or second lens in the carrying ring with the holding elements is suitable for projection objectives having extremely stringent desired properties.

Furthermore, it is advantageous that the solution is very simple and few individual parts are involved.

The forces and/or moments which realize the deformation of the first and/or second lens advantageously act directly on the holding element. As a result, the force flux is very short, and no substances such as adhesive or solder which tend towards creapage effects as a result of loading are situated between force input and lens.

In a further configuration, a first contact area of the at least two contact areas is arranged on the object side and a second contact area is arranged on the image side at the lens, wherein the first contact area is in contact with an object-side edge area of the lens and the second contact area is in contact with an image-side edge area of the lens.

In this case, it is advantageous that the lens is mounted between the first and the second contact area. This results in a stable mounting of the lens between the two contact areas, such that it is possible to effect a force and/or moment input onto the first contact area and/or the second contact area.

In a further configuration, the force and/or moment input is in each case effected by the actuator at the respective holding element.

In a further configuration, the respective holding element can be directly connected to the carrying ring.

In this case, by way of example, a non-releasable connection of the holding elements to the carrying ring could be realized.

In a further configuration, the actuator can be arranged between the carrying ring and the holding ring.

As a result, a direct introduction of forces and/or moments onto the respective holding element can be realized in a simple manner.

In a further configuration, the holding elements in each case have a cutout, wherein the cutout has the first contact area and the second contact area and an object-side and an image-side edge area of the respective lens is mounted in the cutout.

The cutout optionally has a V-groove having a first flank, which forms the first contact area, and a second flank, which forms the second contact area. In this case, a respective flank of the V-groove is in contact with a circumferential radius of the first lens and/or the second lens.

In a further configuration, the holding elements in each case have a cutout, wherein the cutout has the first contact area and the second contact area and an object-side and an image-side edge area of the respective lens is mounted in the cutout.

The lens can thereby be mounted in the holding elements. The holding elements are optionally exchangeable, and it is possible to use different embodiments of the holding elements for mounting, wherein an exchange of the holding element can be carried out relatively simply and cost-effectively.

In a further configuration, the first and the second contact area are arranged at the periphery of the respective lens and the respective holding element is mounted in a cutout formed by the first and the second contact area.

In this case, it is possible to use simple holding elements, such as, for example, pin-type holding elements with the first and the second contact area, and the cutout is introduced into the respective edge area of the lens.

This could possibly enable a more stable mounting of the lens by the holding elements.

In a further configuration, the respective holding element has a contact area between the lens and the holding element.

Consequently, the lens can either be mounted on the holding element and is held in its position relative to the holding element on account of its weight, or it can be fixed on an underside of the holding element by a cohesive connection, e.g. an adhesive or solder.

In a further configuration, the holding element has at least one, optionally also one first limb and one second limb and the first, optionally also one limb is connected to the carrying ring and the lens is retained by the second limb.

The holding element optionally thus has a substantially L-shaped configuration.

In a further exemplary embodiment, a cohesive connection is provided between the first limb of the holding element and the lens.

Consequently, the lens can be fixed e.g. by an adhesive-bonding connection to the holding element. Optionally, the fixing to an underside of the holding element is made possible in this case, such that the lens hangs as it were from the holding element and the holding element, which is connected to the carrying ring, is arranged above the lens. This can be advantageous for space reasons.

In a further exemplary embodiment, the force and/or moment input onto the lens is in each case effected by an actuator arranged at the carrying ring in such a way that the force and/or moment input can be transmitted onto the second limb of the holding element.

As a result, the holding elements can optionally be designed in a simple manner. A further advantage is a one-piece embodiment of the holding elements and the carrying ring, since the carrying ring is connected directly to the holding elements and the actuators act on the carrying ring. In this case, by the actuators, a force and/or moment input is exerted at a defined position at the carrying ring and transmitted to the holding element assigned to this position. Since the holding element retains the lens at a locally delimited connecting location, called bearing point, the force and/or moment input is locally delimited. Consequently, by a plurality of holding elements, locally delimited force and/or moment inputs onto the lens can be realized by arranging the actuators at the respective positions of the carrying ring.

In a further configuration, the holding element has a first measuring system, by which the force and/or moment input onto the second limb of the holding element can be measured.

This makes it possible to monitor the force and/or moment input which the holding element exerts on the lens.

Instead of being realized with holding elements having two limbs, all of the abovementioned configurations can, however, also be realized with holding elements having more than two limbs or with holding elements having just one limb, wherein in the latter case the optical element is connected to one side or one end of the one limb and the limb is moveably connected to the carrying ring by the other side or by the other end.

In a further configuration, the carrying ring has a second measuring system, by which the position of the actuator relative to the carrying ring can be measured.

The position of the actuator is e.g. a relative change in length, induced by an external driving arrangement. These determined values of the position of the actuator relative to the carrying ring can be compared with desired values stored in a database, for example. The function of the actuator can thus be monitored.

In the simplest case, the actuators can be finely threaded pins. In a more complicated embodiment, the actuators are piezoelectric adjusting elements incorporated into a closed-loop control circuit which enables active influencing of the deformation of the first and/or second lens. A desired high resolution of the deformation, that is to say differences in the force and/or moment input which are to be realized in correspondingly small fashion, can be realized by a stepping-up transmission gearing.

Another embodiment is also conceivable, in which the contact location between the first and/or the second lens and the respective holding element is always configured in such a way that a positively locking and force-locking fit arises and the resulting holding force is directed radially with respect to the centre of the optical element.

In a further configuration, the carrying ring has carrying ring sections, wherein the number of carrying ring sections corresponds to the number of holding elements and the respective carrying ring sections are connected by solid-state articulations.

Subdividing the carrying ring into different carrying ring sections makes it possible to deform sections of the carrying ring in a targeted manner. A solid-state articulation enables a play-free movement without friction and without maintenance, or lubrication, since a solid-state articulation generally operates without any wear. On account of an elastic deformation, a relative movement takes places between adjacent carrying ring sections. A solid-state articulation is characterized by a location having reduced bending stiffness and is thereby demarcated from the adjacent zones, here the carrying ring sections. Consequently, a kinetic pair is realized in one piece.

The reduced bending stiffness is generally produced by a local cross-sectional reduction, wherein the cross-sectional alteration has different geometrical forms. In general, the tapering has the form of a circle arc. However, it is also possible to use solid-state articulations having abruptly decreasing cross sections or having elliptical cross sections which lead to a respectively different possible relative movement between the carrying ring sections.

In a further configuration, an axial and/or radial position of the respective lens can be set by the holding elements.

This may have become desired, for example, if the axial and/or radial position of the lens has been adjusted on account of transport, heating, vibration and other influences.

In a further configuration, the holding elements are radially resilient holding elements.

By virtue of their spring stiffness, radially resilient holding elements enable an accurate setting of the desired holding force and can compensate for example for thermal expansion differences between the lens and the holding elements.

By virtue of their spring stiffness in the radial direction, the radially resilient holding elements enable an accurate setting of the desired holding force and can compensate for thermal expansion differences between the individual components, meaning here the lenses and the holder. Consequently, the radially resilient holding elements are fixedly connected to the carrying ring, for example by a screw connection.

In a further configuration, at least two holding elements are provided such that they are resilient in the direction of the local axis.

These two holding elements which are resilient in the direction of the local axis can be deformed by actuators in the direction of the optical axis, such that the lens experiences an astigmatism-like deformation.

In a further configuration, further holding elements are provided.

In this case, it is conceivable for the number of holding elements to be equal to the number of actuators arranged peripherally at the first and/or second lens.

According to the disclosure, the object is achieved with regard to a manipulator for a projection objective according to the disclosure, wherein the manipulator has at least one carrying ring and also a first and at least one second actuator, wherein a first force input and/or moment input can be realized by the first actuator and a second force input and/or moment input can be realized by the at least second actuator, wherein the force input and/or moment input differ with regard to at least one of the parameters: intensity of the force and/or moment input, direction of the force input relative to a local optical axis of the carrying ring, direction of the moment input relative to a periphery of the carrying ring.

By virtue of the fact that both force and moment inputs can be realized, wherein the force inputs are directed for example parallel and/or perpendicular to a plane of the manipulator and the first and/or the second moment input can be introduced radially and/or tangentially, the possibility of deforming the carrying ring of the manipulator in wavy fashion is afforded. However, the direction of the force input can also be such that a force vector of the force input forms a different angle from 0° or 90° with the local optical axis.

This wavy deformation can be transferred to the lens if the lens is connected to the inner ring by a holder technique. The lens is deformed in complex fashion as a result of the waviness being transferred from the inner ring to the lens.

In one configuration of the manipulator, the first actuator and/or the second actuator has a first and a second actuator element and the first actuator element is arranged at the top side of the manipulator and the second actuator element is arranged at the underside of the manipulator.

By the two actuator elements, the inner ring of the manipulator, which receives a lens, can be deformed by force input from two directions. The lens is deformed as a result. This advantageously enables a direct force input.

In this case, the force input can advantageously be effected from the image-side and also from the object-side surface of the lens. The magnitude of the force input can be identical or different since the two actuator elements can optionally be driven separately.

In a further configuration of the manipulator, further actuators each having a first and a second actuator element are provided.

Higher-order deformations can thereby be realized.

More complex force and/or moment inputs onto the lens can be realized by actuator elements.

In a further configuration, further actuators each having a first and a second actuator element are provided.

Complex deformations can thereby be transferred to the lens.

In a further configuration, the carrying ring has an inner ring and an outer ring.

Both the function of a supporting ring, also called holder, and a mount for the holding elements are thus realized.

In a further configuration, holding elements which can be connected to the carrying ring are provided, in which holding elements a lens can be mounted, wherein at least two contact areas are provided between the lens and each holding element and the contact areas are arranged substantially opposite one another.

A secure mounting of the lens on two sides (on the object side and on the image side) is realized as a result.

In this case, it is advantageous that a positively locking connection between lens and inner ring is not involved. The force and/or moment inputs can be transmitted by actuators to the holding elements, which thus deform the carrying ring. In this case, the holding elements are optionally radially resilient holding elements having a V-groove, wherein in each case a first flank, which forms the first contact area, and a second flank, which forms the second contact area, of the V-groove are in contact with a circumferential radius—arranged on the object side and/or on the image side—of the first and/or second lens.

In one configuration, holding elements which can be connected to the carrying ring are provided, by which holding elements a lens can be mounted, wherein the holding elements have a substantially L-shaped configuration with a first limb and a second limb.

In this case, the first limb is connected to the carrying ring, wherein the connection can be releasable or the holding elements can be connected to the carrying ring in one piece. The second limb realizes the mounting of the lens. Consequently, the force and/or moment input is effected in each case in a locally delimited manner at the positions at which the second limb is in contact with the lens.

In a further configuration, it is provided that the holding elements are connected to the carrying ring by solid-state articulations.

Solid-state elements permit a play-free connection of two fixed partners which perform a relative movement under force influence.

Optionally, the manipulator has at least one carrying ring and at least four holding elements, wherein the first lens and/or the second lens is mounted in the holding elements and an axial and radial position of the respective lens can be set by the at least four holding elements.

Optionally, at least two holding elements are designed to be resilient in the direction of the local optical axis. Furthermore, further holding elements can be provided. Starting from a number of eight holding elements, a higher-order deformation is possible at the lens.

These deformations can produce second- or higher-order deformations and also a linear combination thereof and therefore compensate for the deformations or refractive index changes of the lens of the projection objective which are attained by heating, for example.

According to the disclosure, the object is furthermore achieved with regard to a microlithography apparatus including a projection objective according to the disclosure and/or a manipulator according to the disclosure.

Improved imaging properties of the mask onto the substrate can thereby be realized.

According to the disclosure, the object is additionally achieved with regard to a method for improving the imaging properties of a projection objective, wherein the projection objective has a plurality of lenses each having a local optical axis, wherein forces and/or moments for the complex deformation of at least one first lens of the projection objective are input, wherein the forces and/or moments that are input are input at each of the at least two locations of the first lens, and differ with regard to at least one of the parameters: intensity of the force and/or moment input, direction of the force input relative to the local optical axis, direction of the moment input relative to a periphery of the first lens.

In this case, by way of example, the input of the forces can be effected either parallel and/or perpendicular to the local optical axis of the first lens and/or the input of the moment can be effected either radially and/or tangentially.

In this case, it is advantageous that as a result of the different input of forces and/or moments at the lens, a complex deformation of the first lens is realized which largely corrects the aberrations produced by heat input or material compaction. The different input of forces and/or moments is optionally realized by virtue of the fact that it is effected at in each case two positions of a location and at least two locations. In particular aberrations, brought about by thermal disturbances of the lens, that is to say by material heating, and resultant deformations of the lens, are corrected.

In a further configuration of the method, the forces and/or the moments are input at further locations, wherein the locations are in each case arranged peripherally at the first lens and are in each case offset by 180°.

Higher-order deformations can thereby be realized.

In a further configuration of the method, at least one second lens of the projection objective can be deformed by virtue of the fact that, at at least two locations and in two ways, forces are introduced parallel and/or perpendicular to the local optical axis of the first and/or the second lens and/or moments are introduced radially and/or tangentially.

It is thereby possible to correct low-order deformations and higher-order deformations independently of one another.

In a further configuration of the method, the first and/or the second lens of the projection objective can be deformed by the force and/or moment input being effected at the carrying ring, wherein the locations of the force and/or moment input are assigned to the holding elements.

A locally delimited and precisely defined force and/or moment input at the lens is thereby realized.

The force and/or moment input at the carrying ring is transmitted to the holding element, wherein the relative movement between carrying ring and holding element is realized by solid-state articulations assigned to the respective holding element and the force and/or moment input is transmitted to the lens by the holding elements.

Further advantages and features emerge from the following description and the accompanying drawing.

It goes without saying that the features mentioned above and those yet to be explained below can be used not only in the combination respectively specified, but also in other combinations or by themselves, without departing from the scope of the present disclosure.

The present disclosure is explained in more detail below on the basis of selected exemplary embodiments. In the drawing:

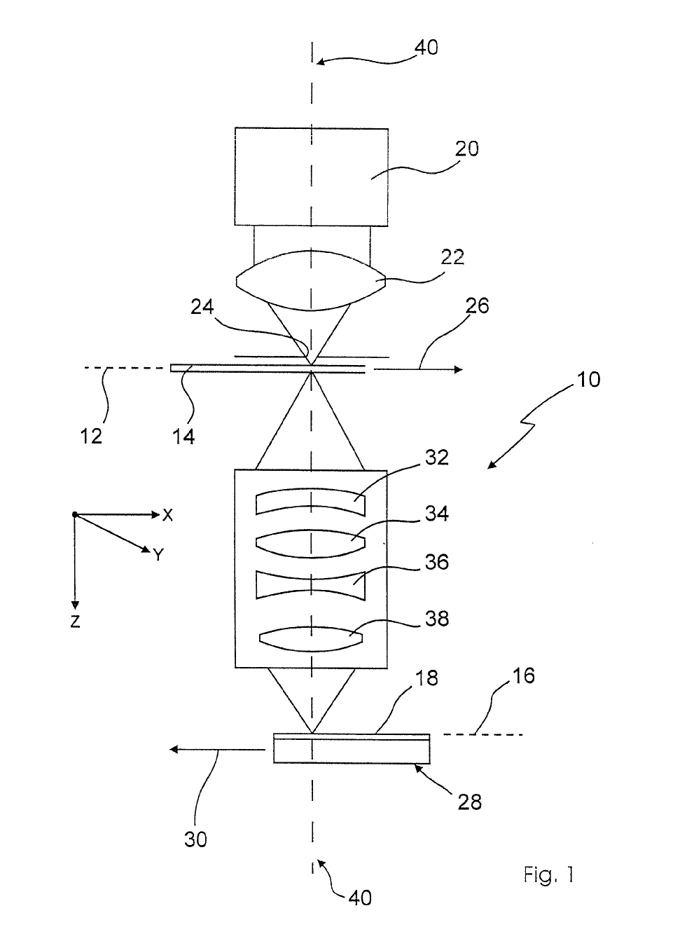

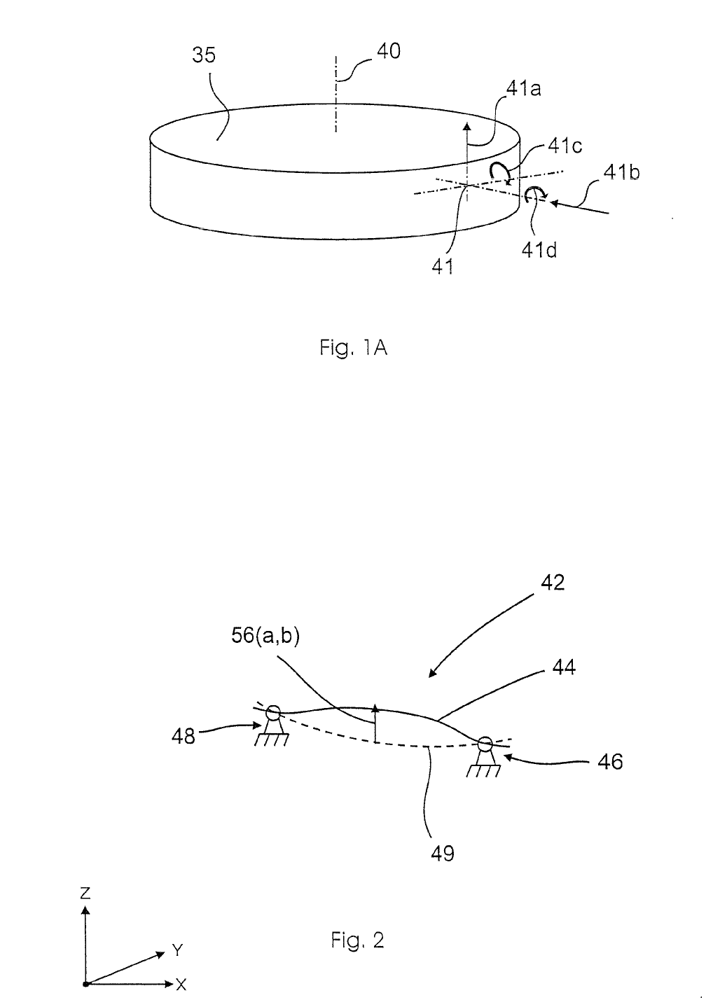

FIG. 1 shows a schematic illustration in longitudinal section along an optical axis of a projection objective in a microlithography apparatus;

FIG. 1A shows by way of example an optical element with local optical axis, illustrating which forces and moments can be exerted in principle and advantageously;

FIG. 2 shows a schematic illustration of an optical element, in particular a lens, with two actuators, illustrated as a section along a local optical axis of the lens;

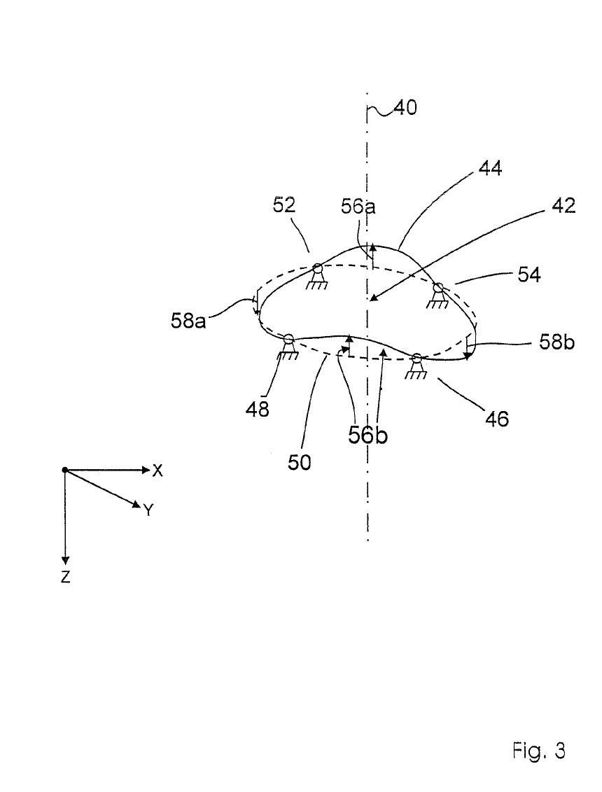

FIG. 3 shows an optical element with four actuators, illustrated as an oblique plan view;

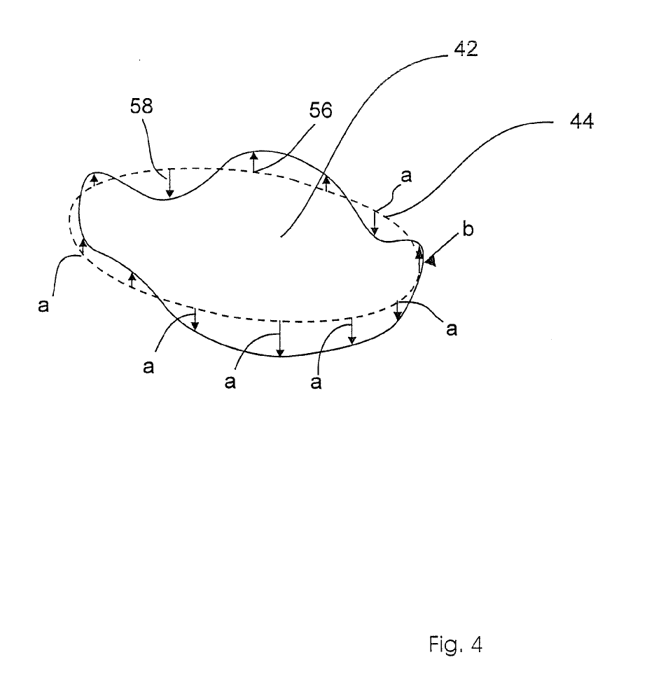

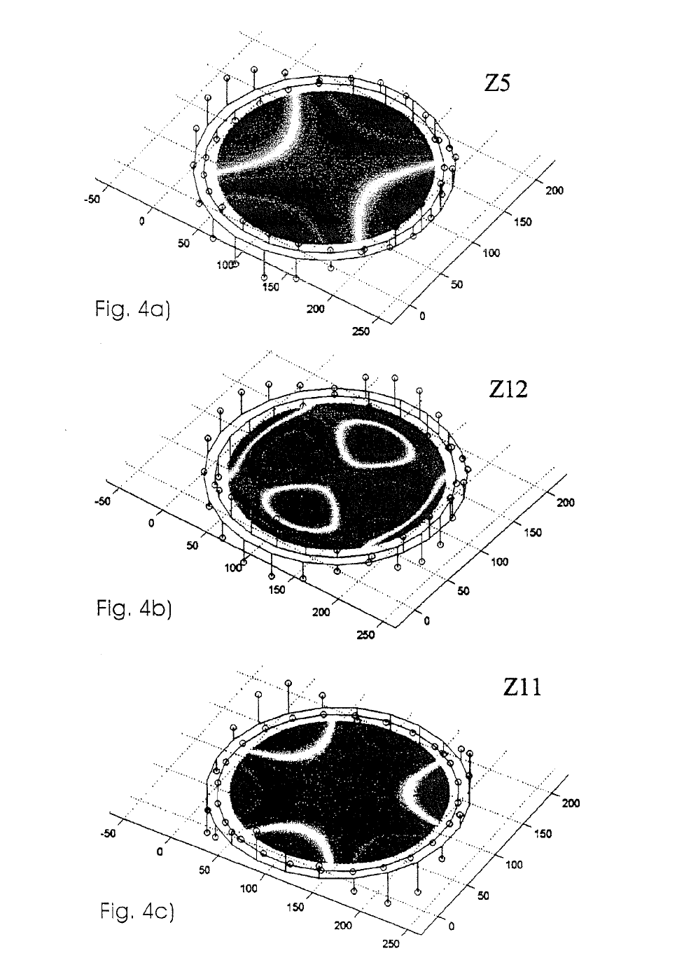

FIG. 4 shows an optical element in a schematic illustration in plan view with a plurality of actuators and resulting deformation of the optical element;

FIGS. 4a) to 4c) show by way of example an optical element in oblique plan view in a grey-scale representation of the optically utilized region of the optical element, wherein different grey-scale levels illustrate different deformations of the optical element;

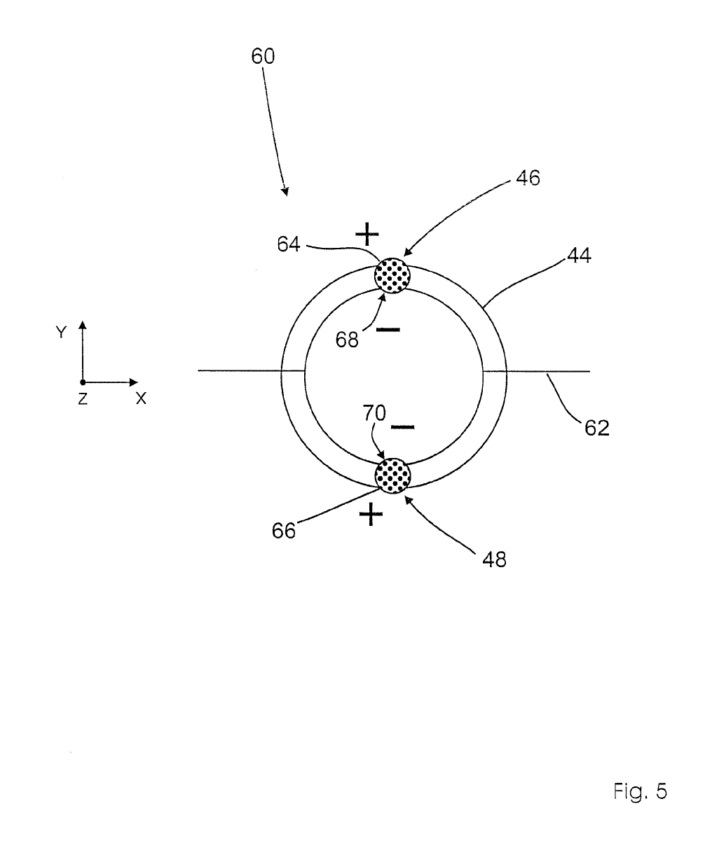

FIG. 5 shows a schematic illustration in plan view of an optical element with manipulator and two actuators;

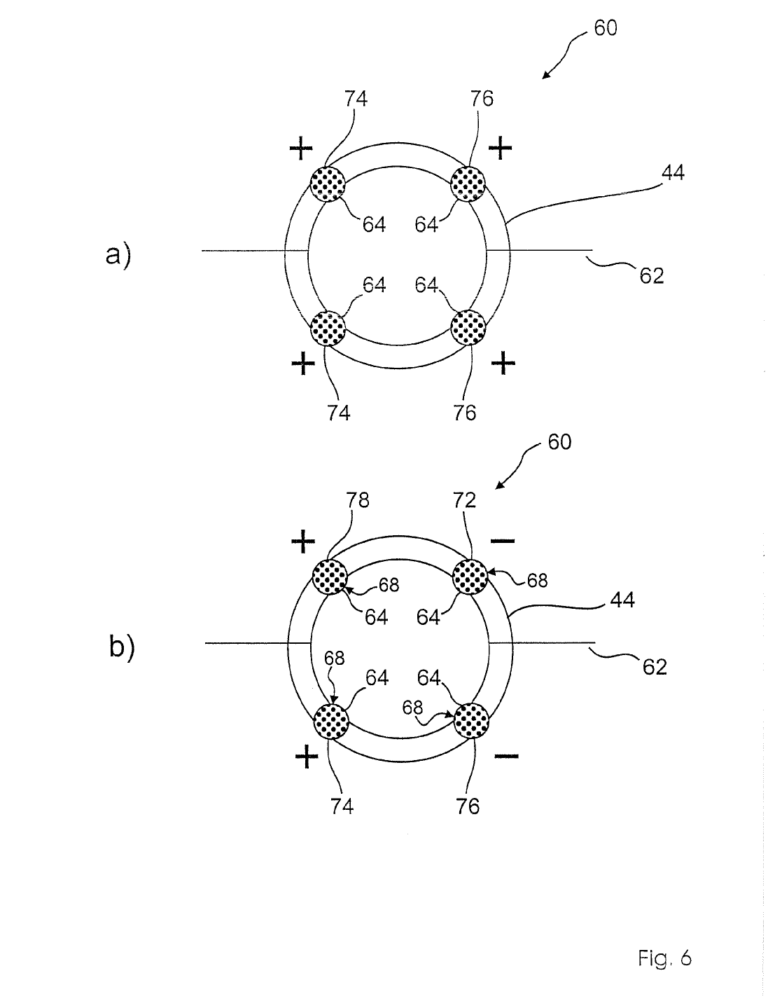

FIG. 6a)-6b) shows a schematic illustration in plan view of an optical element with manipulator and four actuators;

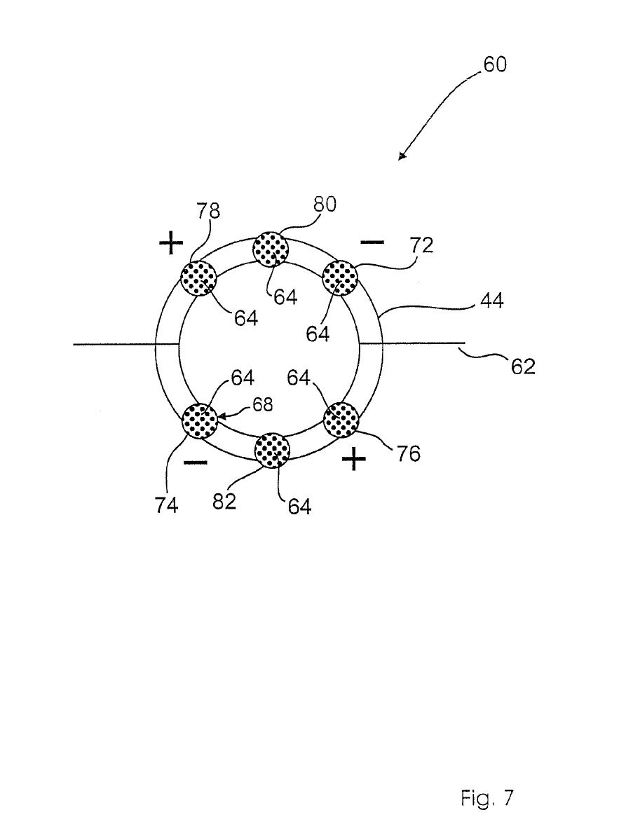

FIG. 7 shows a schematic illustration in plan view of an optical element with a manipulator and six actuators;

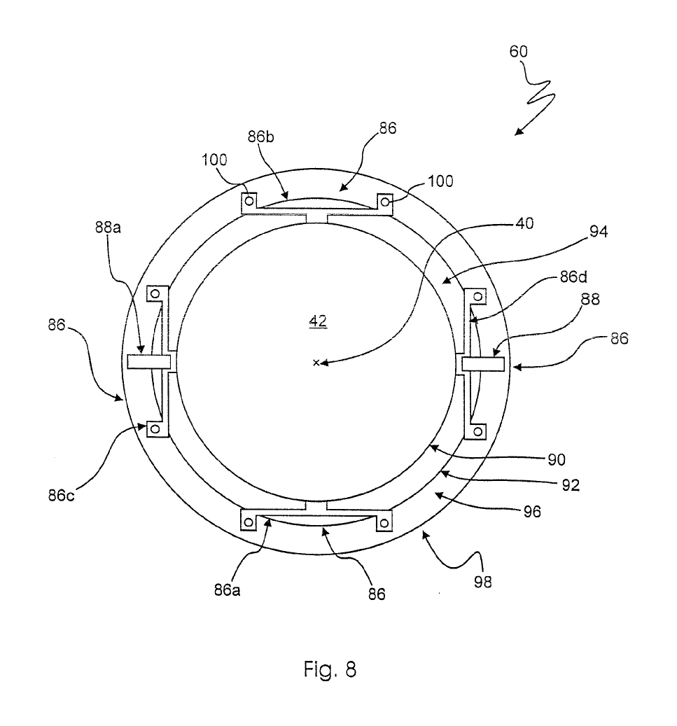

FIG. 8 shows a schematic illustration in plan view of a manipulator with four holding elements;

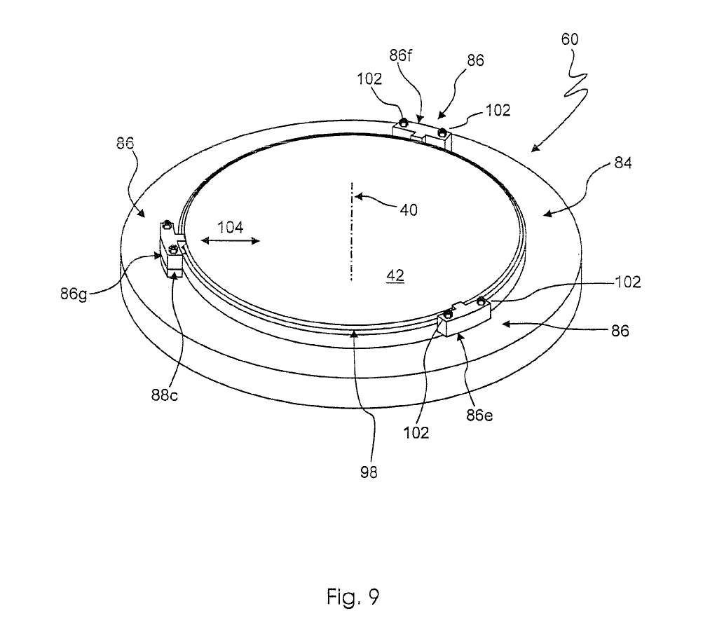

FIG. 9 shows a schematic perspective illustration of an optical element with manipulator and three holding elements;

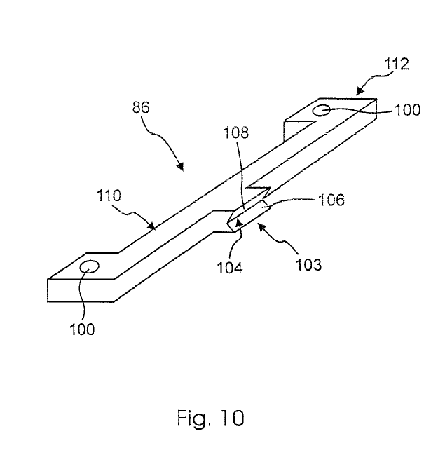

FIG. 10 shows a schematic perspective illustration of a first exemplary embodiment of a holding element;

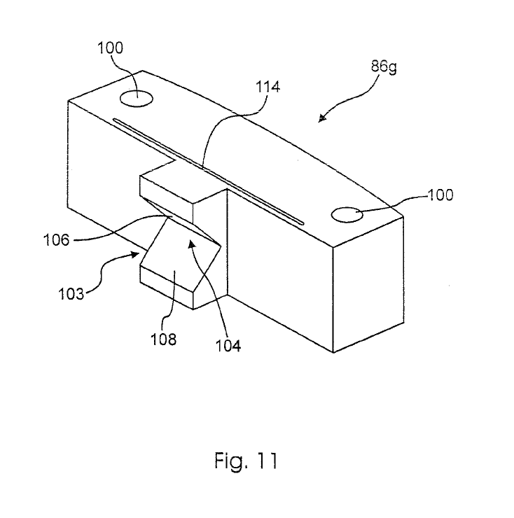

FIG. 11 shows a schematic perspective illustration of a second exemplary embodiment of a holding element;

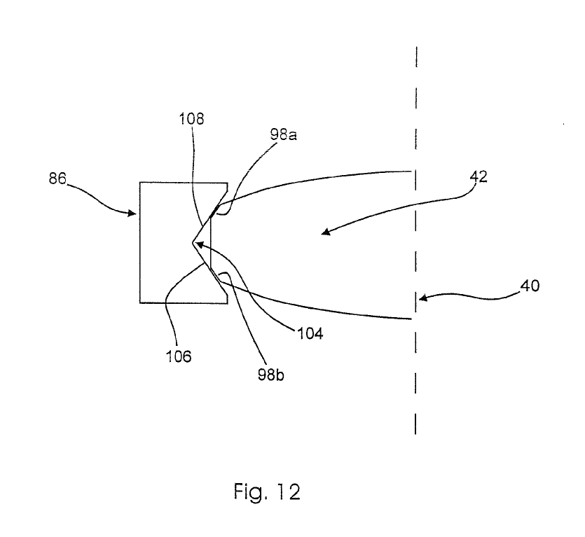

FIG. 12 shows a schematic illustration of the holding element and of the optical element mounted in the holding element in a sectional illustration along the optical axis;

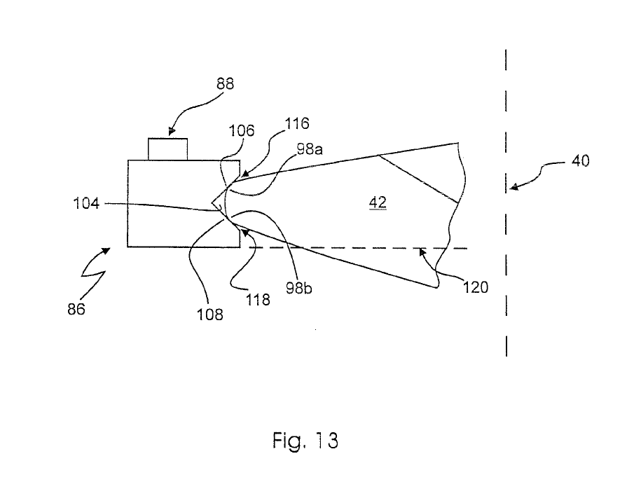

FIG. 13 shows a further exemplary embodiment of a holding element in a schematic sectional illustration along the optical axis;

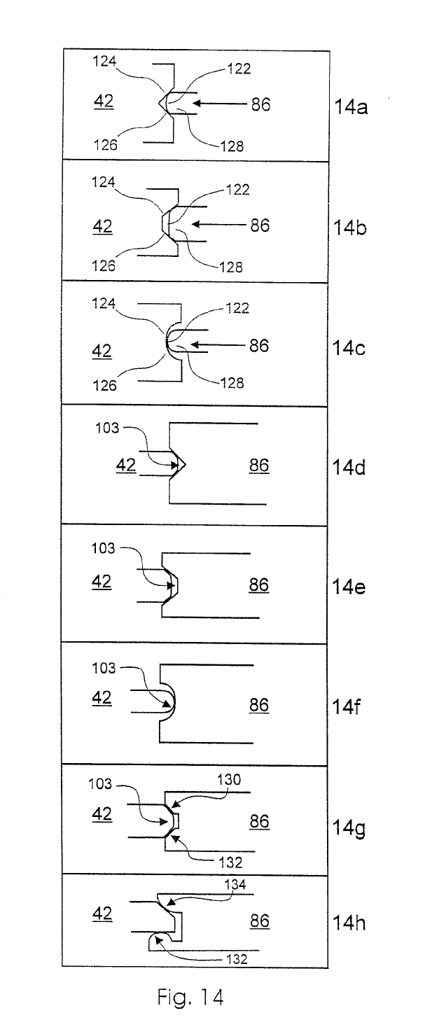

FIG. 14a)-14h) shows various exemplary embodiments for the mounting of the optical element in the holding element in sectional illustration along the optical axis;

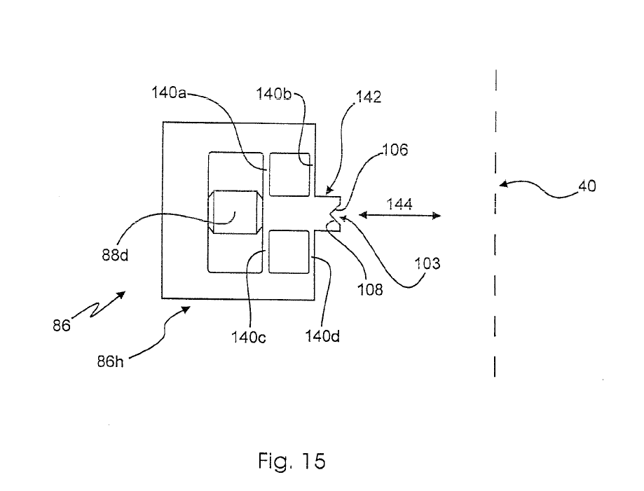

FIG. 15 shows a further exemplary embodiment of a holding element in sectional illustration;

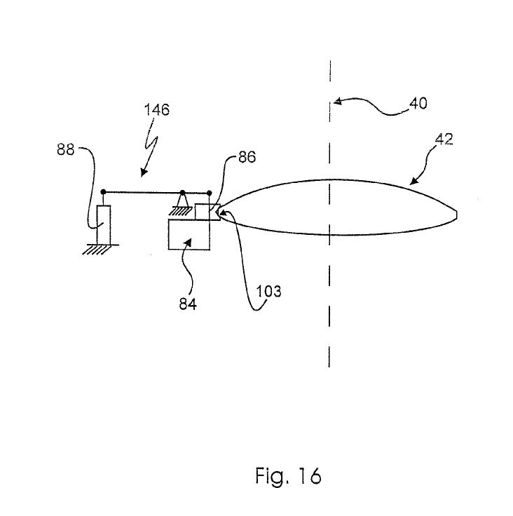

FIG. 16 shows the optical element mounted in the holding element, with a first exemplary embodiment of an actuator acting on the holding element in sectional illustration along the optical axis of the optical element;

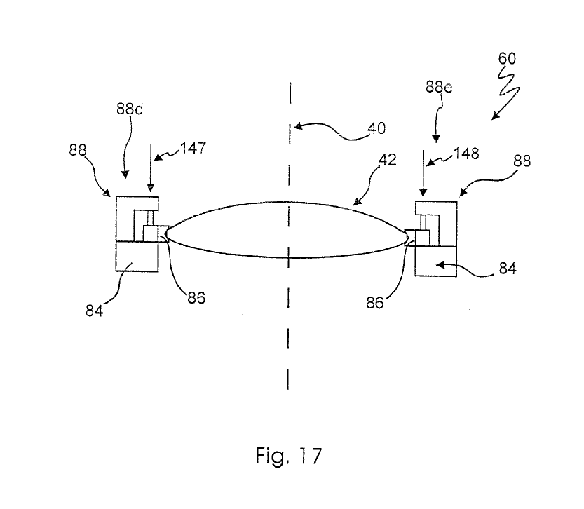

FIG. 17 shows the optical element mounted in the holding element, and a further exemplary embodiment of an actuator acting on the holding element in sectional illustration along the optical axis of the optical element;

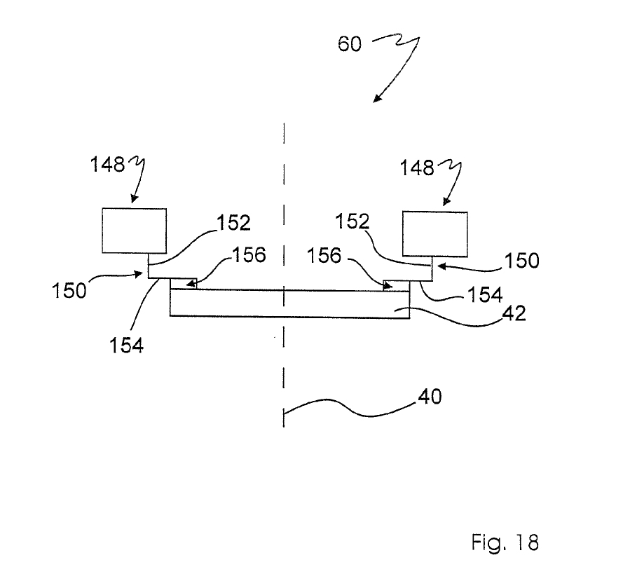

FIG. 18 shows the optical element, mounted by the manipulator with holding elements in accordance with a further exemplary embodiment in sectional illustration along the optical axis of the optical element; and

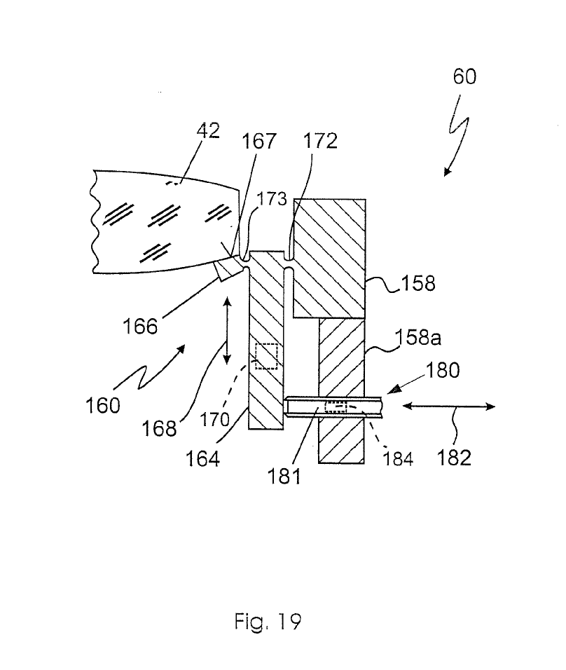

FIG. 19 shows a partial illustration of a further exemplary embodiment of a manipulator, partially in section.

A projection objective, which is provided with the general reference symbol 10, for a microlithography apparatus is illustrated extremely schematically in FIG. 1. The projection objective 10 is used in a microlithographic production process for imaging a pattern 14 arranged in an object plane 12 onto a substrate 18 (wafer) arranged in the image plane 16. The light involved for imaging the pattern 14 onto the substrate 18 is generated by a light source 20, which is a laser, for example, and directed by an illumination system 22 onto the pattern 14, from which the light then enters into the projection objective 10.

In so far as reference is made in the present description to the projection objective 10 as imaging device for imaging the pattern 14 onto the substrate 18, it goes without saying that a projection objective in the sense of the present disclosure can also be realized as part of the illumination system 22.

The imaging of the pattern 14 onto the substrate 18 is effected in a so-called scanning method, in which the light is directed through a scanner slot 24 by the illumination optical unit 22, the slot width of said slot being smaller than the dimensioning of the pattern 14. In order gradually to image the entire pattern 14 onto the substrate 18, the pattern 14 is moved in a scanning direction 26, while the substrate 18, which is arranged on a table 28, is moved in direction 30 opposite to the scanning direction 26. Depending on whether the projection objective 10 effects a 1:1 imaging or a demagnifying imaging of the pattern 14 onto the substrate 18, the substrate 18 is moved at the same speed as the pattern 14 or a speed reduced by the demagnifying factor.

The projection objective 10 is stationary during the scanning operation, that is to say only the substrate 18 and the pattern 14 are moved relative to the projection objective 10.

The projection objective 10 has a plurality of optical elements, four optical elements 32, 34, 36, 38 in the schematic illustration, which are optionally formed as lenses. Each lens has a local optical axis 40, this being the optical axis of the projection objective in the illustration.

The shaping and the number of the optical elements 32 to 38 are shown only by way of example and schematically in FIG. 1 and are not restricted to the embodiment shown.

The optical elements 32 to 38 are arranged one behind another along the light propagation direction between the object plane 12 and the image plane 16 and have a common optical axis. In this case, the light propagation direction in accordance with FIG. 1 runs in the direction of the z axis of the system of coordinates illustrated. The scanning direction 26 in FIG. 1 runs in the direction of the x axis, and the scanner slot 24 extends with its long dimension in the direction of the y axis.

In general terms, the projection objective 10 has optically active assemblies which are different in the sense of the light exit depending on the microlithography apparatus. Purely dioptric, purely catoptric and catadioptric assemblies are provided in this case. The projection objective 10 can have in each case a plurality of assemblies from the three types of assemblies mentioned above.

The first lens according to the disclosure and also the second lens, which are actively moveable/deformable lenses in this case, can be chosen from the dioptric, the catoptric and also the catadioptric assemblies. In this case, it should merely be taken into consideration that the first lens and the second lens are chosen from different types of assemblies.

In addition to the types of assemblies, the projection objectives 10 used also differ in the numerical aperture of the projection objective 10. Numerical apertures of between 0.8 and 1.5 are typical values for the numerical aperture in this case.

One example of the arrangement of the lens of a projection objective including—in the direction of light passage—the following order of the optically active assemblies is: a first, purely dioptric part with positive refractive power, a biconcave lens, a third, purely dioptric part with positive refractive power, wherein the first lens is contained in the first, dioptric part and the at least second lens is contained in the third, dioptric part. An optimum improvement of the imaging properties of the projection objective can thus be obtained in the case of the projection objective according to the disclosure. The first and the second actively deformable lens are therefore arranged at different positions in the projection objective and therefore have different wavefront influences.

FIG. 1A illustrates an optical element 35 by way of example, which optical element can be present or used in the projection objective 10. Furthermore, FIG. 1A shows the local optical axis 40. At a peripheral location 41 of the lens or optical element 35, advantageous forces and moments are illustrated by arrows by way of example, which can act directly or indirectly on the lens 35 according to the present disclosure. These are an axial force 41a, a radial force 41b, a radial moment 41c and/or a tangential moment 41d.

FIG. 2 shows the principle of deforming an optical element, here a lens, by introducing forces. The lens is mounted in principle in a manipulator, of which here only an inner ring 49 is shown, which inner ring is assigned closest to the periphery (not shown here) of the lens 42. Furthermore, two holding points 46 and 48 are shown, which fix the inner ring 44 to the outer fixed world (e.g. an outer ring). Said holding points hold the inner ring by way of example in such a way that no moments can be transmitted via the holding points. An actuator force 56 is further shown by way of example, which actuator force is directed onto the inner ring 49 and thereby deforms the latter. The deformed inner ring is represented by 44. The deformation of the inner ring 49 is then transferred to the lens 42.

The mode of operation shall be shown here in connection with FIG. 3, which shows the lens 42 and also the deformed inner ring 44 as a plan view at an oblique angle. By way of example, the lens is adhesively bonded into the inner ring 44 by a holder technique. However, provision is also made for holding the lens in a manipulator having so-called holding elements, which are explained with reference to exemplary embodiments concerning FIGS. 8 to 17.

A lens has in this exemplary embodiment, viewed from above, that is to say in plan view, a circular shape, which can be discerned rather as an ellipse in the oblique illustration.

The dashed line 50 represents the lens 42 or the inner ring 44 in the rest state. If the actuators become active, forces and/or moments occur with the arrows 56 pointing in the positive z direction, and also with the arrows 58 pointing in the negative z direction of the system of coordinates illustrated. In this case, 46, 48, 52 and 54 are holding points of the inner ring to an outer fixed world. A further advantageous embodiment without holding points is illustrated in FIG. 4.

The forces are directed substantially parallel to the local optical axis 40 of the lens or substantially perpendicular to the local optical axis. The moments are tangential moments and/or radial moments. What is essential in this case is that the actuators realize at least two different forces and/or moments of the abovementioned types in order to obtain the complex deformation of the lens.

Optionally, each actuator 56, 58 has a first actuator element and also a second actuator element, the actuator elements not being illustrated in FIGS. 2 and 3. These are explained in connection with FIGS. 4 to 6.

It can furthermore be discerned that in each case two actuators, here the actuators 56a and 56b and 58a and 58b, are arranged peripherally and in a manner offset by 180°, that is to say are diametrically opposite one another. The actuator elements 56a and 56b illustrated in FIG. 2 therefore correspond in each case to a so-called actuator pair, that is to say two diametrically opposite actuator elements.

FIG. 3 illustrates forces in the direction parallel to the local optical axis of the lens.

FIG. 4 shows a lens 42 or the inner ring 44 thereof in a deformed state (solid line). It can be discerned in this case that the inner ring 44 is deformed in wavy fashion. This is effected by way of example by a total of twelve actuators which input different forces into the inner ring 44. Forces parallel to the local optical axis are illustrated by arrows with the reference symbol a. In this case, the forces have different intensities, shown by the different lengths of the arrows a. The different signs of the forces are indicated by the different directions of the respective arrows a.

Forces perpendicular to the local optical axis are likewise illustrated, provided with the reference symbol b. Moments which act on the lens tangentially or radially are not illustrated.

In this case, FIG. 4 illustrates how two different types of forces, namely forces perpendicular and forces parallel to the local optical axis of the lens, realize a wavy deformation of the lens.

FIGS. 4a) to 4c) illustrate an optical element in oblique plan view, in which by way of example different force/moment inputs are illustrated by different grey-scale levels. Furthermore, axial force pairs are illustrated by circular arrows at twenty-four peripheral locations of the optical element in FIGS. 4a) to 4c). In total, an axial force pair can exert a combination of an axial force and a tangential moment on the lens. Combinations of force pairs can also generate radial moments. The distribution of the axial force pairs, which is by way of example here, produces within the optically utilized region in the case of FIG. 4a) a Z5-like, in the case of FIG. 4b) a Z12-like and in the case of FIG. 4c) a Z11-like deformation of the lens.

It has become clear that at least two different types of forces and/or moments are input onto the lens by the actuators and the complex deformation is thus realized; in this case, the forces and/or moments differ with regard to at least one of the parameters: intensity of the force and/or the moment input, direction relative to the local optical axis 40 of the force input, direction of the moment input relative to a periphery of the lens.

Using this principle, second-order, third-order or higher-order aberrations and also a combination, in particular a linear combination, thereof can be produced in a targeted manner onto the lens 42.

Through the use of the manipulators, or the actuators of the manipulators, the plane of the inner ring and hence the plane of the lens is defined as seen in the z direction. By the manipulation, or the input of the forces by the actuators, the lens can be deformed in the z direction, while the position remains unchanged in the z direction.

These lens deformations that are produced can advantageously be used to compensate for temperature effects which bring about deformations by material heating of the lens as a result of temperature input during the operation of the projection objective, so-called lens-heating effects. Furthermore, they can also be used to compensate for compaction effects such as occur during the lifetime of a lens as a result of material alteration, and to compensate for transport effects. It is also conceivable to use a targeted deformation of the lens by the actuators during the process of aligning the individual lenses in the projection objective.

In this case, it is possible to use the Zernike polynomials, as are generally used for describing aberrations, but it is also possible to use other function descriptions such as e.g. Chebyshev polynomials, splines or, especially for the surface description, also a modal superposition description.

FIG. 5 shows a manipulator with an inner ring 44, a first actuator 46, and also a second actuator 48. A fixing 62 of the manipulator 60 to an outer ring (not illustrated here) can likewise be discerned. The illustration of the manipulator has been chosen as a plan view, such that only a first actuator element 64 of the actuator 46 and a first actuator element 66 of the second actuator 48 are visible. A second actuator element 68 of the first actuator 46 and a second actuator element 70 of the second actuator 48 are in each case arranged below the inner ring 44, that is to say are opposite the first actuator element 64 and the first actuator element 66, respectively.

Due to the plan view, the second actuator element 68 of the first actuator 46 and the second actuator element 70 of the second actuator 48 cannot be discerned. It can be discerned, however, that the first actuator element 64 of the first actuator 46 and the first actuator element 66 of the second actuator 48 are arranged on the top side of the inner ring 44.

The first actuator elements 64 and 66 exert a force from above on the inner ring 44. Said force is provided with the plus symbol. The second actuator elements 68 and 70 exert a force from below on the inner ring 44. Said force is therefore provided with a minus symbol. As an alternative, it is possible to choose one actuator element per actuator, which can exert forces or displacements both in the positive direction and in the negative direction.

Consequently, either the upper actuator element 64, or 66 or the lower actuator element 68 or 70 is active, wherein a movement—as seen in the z direction—downwards is realized in the case of an active upper actuator element 66 or 64, and a movement of the inner ring 44 upwards is realized in the case of the active second actuator element 68 or 70.

As seen in the nomenclature of the Zernike polynomials, Z5 aberrations can thereby be corrected. Optionally, the first and also the second actuator element are in each case provided with a bellows, wherein the bellows are able to be driven pneumatically. However, it is also possible to choose a different transmission of the movement to the actuator element, for example by piezoelectric elements, and also mechanically, hydraulically and/or electrically and/or magnetically.

The advantage of the arrangement of a first actuator element and a second actuator element is that in the event of the failure of one of the actuator elements, the lens remains in an unchanged position. No deformation of the lens takes place, and the lens remains in the position as when actuators are not present. It is furthermore advantageous that in the event of the failure of one or more actuator elements, the respective pairs can be shut down, such that no force input is effected onto the lens 42 by actuators.

FIG. 6 shows, in the embodiment of FIG. 6a and FIG. 6b, in each case a manipulator 60 with inner ring 44 and fixing 62 and also four actuators 72, 74, 76 and 78, wherein in each case two actuators are arranged diametrically opposite one another. Each actuator 72, 74, 76, 78 has a first actuator element 64 or 66 and also a second actuator element 68, or 70, which is not illustrated.

For simplification, the reference numerals 64 have in each case been chosen for the first actuator element of the actuators 72, 74, 76 and 78, and the reference numerals 78 for the second actuator element of the actuators. In this case, as in FIG. 5, the first actuator element is arranged above the inner ring 44 and the second actuator element 68 is arranged below the inner ring 44. The designations (+) and (−) represent different force inputs, wherein, as in FIG. 5, the minus symbol means that the lower actuator element 68 is active, and the plus symbol means that the upper actuator element 64 is active, that is to say that a force input is effected from above (for actuator element 64) and a force input is effected from below (for actuator element 66).

By this means, positive Z5 deformations can be realized in the example illustrated in FIG. 6a, and positive Z10 deformations can be realized in the example illustrated in FIG. 6b.

It is evident that the upper actuator elements 64 of the actuators 72 to 78 are active for positive Z5 deformations. Two upper actuator elements 64 of the two actuators 74 and 78, and also two lower actuator elements 68 for the two actuators 72 and 76 are active for the positive Z10 deformations illustrated in FIG. 6b. Table 1 summarizes this situation.

TABLE 1

| | | Actuator No. |
|---|---|---|
| | | 46 and 48 |
| Deformation-Zernike | Z5 Positive | + |
| | Z5 Negative | − |

FIG. 7 illustrates an example of a manipulator 60 with the inner ring 44 and a total of six actuators 72, 74, 76, 78, 80, 82. The actuators, like the actuators already in the exemplary embodiments illustrated in FIGS. 5, 6, in each case have a first actuator element 64 and also a second actuator element 68, which is arranged at the underside of the inner ring. Once again the force input by the first actuator element 64 is designated by (+) and the force input onto the inner ring by the active second actuator element 68 is designated by (−). Z5, Z6, Z17 lens deformations can be realized by this means. In addition to the actuators 72 to 78, actuators 80 and 82 arranged diametrically opposite one another can be discerned. This is summarized in Table 2.

What is common to the exemplary embodiments of a first manipulator which are shown in FIGS. 5, 6 and 7 is that lens aberrations both due to thermal effects and due to material alterations (compaction) can be corrected. In this case, both low-order and higher-order corrections can be realized, to be precise with both signs, i.e. Z5 and Z6, and also Z10 and Z11, and also Z17, Z18 and Z21.

Tables 2 and 3 show, in summarized fashion, low- and higher-order deformations that can be realized for the use of different actuators.

TABLE 2

| | | Actuator No. | |
|---|---|---|---|
| | | 74 and 78 | 72 and 76 |
| Deformation-Zernike | Z5 Positive | + | + |
| | Z5 Negative | − | − |
| | Z10 Positive | + | − |
| | Z10 Negative | − | + |

TABLE 3

| | | Actuator No. | | |
|---|---|---|---|---|
| | | 74 and 78 | 72 and 76 | 80 and 82 |
| Deformation- | Z5 Positive | ◯ | + | ∘ |
| Zernike | Z5 Negative | ◯ | − | ∘ |
| | Z6 Positive | + | ∘ | − |
| | Z6 Negative | − | ∘ | + |
| | Z17 Positive | + | − | + |
| | Z17 Negative | − | + | − |

In the actuators of all the exemplary embodiments shown, the actuator elements are optionally provided with bellows which permit a pneumatic drive for moving the respective actuator element. The inner ring is fixed by the fixing 62 firmly to an outer ring (not illustrated in the figures).

Furthermore, no movement of the lens 42 occurs per se in the z direction, that is to say in the direction of the optical axis 40, since the lens is mounted in the manipulator and is fixed in its position in the projection objective 10. Furthermore, no movement of the lens as such in the xy plane is to be expected, since the manipulator 60 also ensures a fixing of the lens in the projection objective in the xy plane.

The lens deformations described in FIGS. 2 to 7 can be used at a first lens of the projection objective 10 and also at a second lens of the projection objective 10 of a microlithography apparatus. In principle, it is also conceivable to provide even more lenses with a manipulator such that these can also be deformed in a targeted manner.

If two or more optical elements, that is to say lenses, arranged at different positions in the projection objective are combined with one another in such a way that said lenses have similar deformations but have different wavefront influences as a result of the different positions in the projection objective 10, then a more complicated wavefront influence results in the combination. Said influence can be obtained in a targeted manner in the combination with a plurality of lenses in the projection objective. In particular, it is thereby possible to influence the low-order and higher-order deformations in decoupled fashion in the image.

Optical elements should be understood here to mean, besides lenses, also mirrors which are arranged in the projection objective 10. In this case, the optical elements can be arranged at two or more adjacent or at conjugate positions in the projection objective. The different locations/positions in the projection objective 10 have a different influence on the wavefront in the deformation. Aberration of lowest radial order should be understood to mean e.g. Z5, Z6, Z10 and Z11 aberrations, and higher radial orders should be understood to mean e.g. Z12, Z13, Z19, Z21, etc. In this case, it should particularly be emphasized that the described method and the input of axial forces make it possible to produce a different ratio of Z5/Z12, for example, from that for example using tangential moments input at the edge of the lens. A general illustration of the term ‘higher radial order’ which is used herein for the purposes of explaining the present disclosure is given in the US-book with the title “Optical Shop Testing”, edited by Daniel Malacara, Wiley Series in Pure and Applied Optics, second edition, 1991, chapter 13.2.2. “Zernike polynomials”, in particular table 13.1 on page 463, which is incorporated in the present application by reference. The lowest radial order is given by the diagonal of table 13.1, which corresponds to radial shapes of the waviness which correspond to a monom in the radial argument r. The next higher radial order is given by the polynoms of the first secondary diagonal.

It is possible, in principle, to produce all lowest radial orders (e.g. Z5, Z6, Z10, Z11) and also all next higher radial orders (e.g. Z12, Z13, Z19, Z20 . . . ) on the surface (in this respect, cf. as an example FIGS. 4a) to 4c)). If two or more of the active lenses are combined, any image aberration can be corrected, in principle. Different field profiles, that is to say constant, linear, quadratic, should be corrected in this case. Said image aberrations are dependent on the effects which were produced by the temperature input, material alterations or faults during the production of the lens.

FIG. 8 illustrates a first exemplary embodiment of a manipulator 60 with lens mounted in the manipulator 60, wherein the lens can be selected from the plurality of lenses 32, 34, 36, 38 and/or 42, designated as lens 42 in a representative fashion here. The optical axis 40 is identified here by a cross and runs perpendicular to the plane of the drawing. The lens 42 is taken up by four holding elements connected to a carrying ring 84. The reference numeral 86 is used hereinafter whenever the holding element generally is described.

In this case, the lens 42 has at its edge two circumferential radii, a first circumferential radius 90 and a second circumferential radius 92, such that at least one first optical edge area 94, and optionally a second optical edge area 96 are formed, which form an edge region 98.

The holding elements 86 are optionally radially resilient holding elements. FIG. 8 shows four holding elements 86a, 86b, 86c, 86d for retaining the optical element 42 in the carrying ring 84, wherein the holding elements 86a and 86b are arranged diametrically opposite one another. A holding element 86c and a further holding element 86d are likewise arranged diametrically opposite one another. However, it is also possible to provide additional holding elements 86.

The reference numeral 88 is used for an actuator which adjoins one of the actuator elements 86a, b, c, d.

An actuator 88a acts on the holding element 86c, and an actuator 88b acts on the holding element 86d, wherein the respective holding element 86c or 86d experiences a force and/or moment input that is passed on to the lens 42, such that the lens 42 is deformed.

The holding elements 86c, 86d can be deformed by the actuators 88a and 88b optionally in the direction of the optical axis 40, such that the optical element 42 experiences an astigmatism-like deformation.

In this case, the actuators 88a and 88b obtain a force input onto the holding elements 86c and 86d which is directed substantially optionally parallel to the optical axis 40.

By virtue of their spring stiffness in the radial direction, the radially resilient holding elements 86 enable an accurate setting of the desired holding force and can compensate for thermal expansion differences between the individual components, for example the lens 42 and the carrying ring 84.

The radially resilient holding elements 86 are optionally fixedly connected to the carrying ring 84, for example by screw connections, as is indicated by the circles 100 at the holding elements 86a, 86b, 86c and 86d in FIG. 8. However, it is also possible to choose a different type of connection.

In the simplest case, the actuators 88 are finely threaded pins, but provision is also made for embodying the actuators 88 as piezoelectric adjusting elements. In this case, each actuator is assigned a dedicated closed-loop control circuit, such that a force action can be realized on each of the actuators independently of one another. This enables active influencing of the deformation of the lens 42 or of the optical element 42.

It is also conceivable, in particular in order to achieve a finer resolution of the deformation, to use a stepping-up transmission gearing—not shown here.

Various embodiments of a first and the second contact area between optical element 42 and holding element 86 are conceivable. Optionally, a positively locking and force-locking fit can be produced, and the resulting holding force is directed radially with respect to the centre of the optical element, that is to say of the lens 42.

By virtue of the fact that the forces for introducing the deformation onto the optical element 42 act directly on the holding element 86, the force flux is very short. Furthermore, optionally no substances such as adhesive or solder which would tend towards creepage effects under loading are situated between optical element 42 and carrying ring 84.

FIG. 9 shows a further exemplary embodiment of the manipulator 60 in perspective plan view, wherein the lens 42 is mounted by holding elements 86 connected to the carrying ring 84. It can be discerned that the holding elements 86 are connected to the carrying ring 84 by small screws 102, optionally hexagon socket screws.

Three holding elements 86e, 86f and 86g are provided in this exemplary embodiment, wherein the holding element 86g is connected to an actuator 88c arranged between the carrying ring 84 and the holding element 86g.

In this case, the force input is effected onto the holding element 86g by the actuator 88c, such that the lens 42 experiences a force input designated by an arrow 104. A third-order deformation of the lens 42 is obtained by this arrangement with three holding elements.

The edge region 98 of the optical element 42 can once again be discerned. The holding elements 86e, 86f and 86g have a cutout, optionally a V-groove, in their holding region, wherein a first contact area—referred to as flank—of the V-groove is in each case in contact with the circumferential radius 92 of the optical element. The contact areas are explained in more detail in connection with FIGS. 10, 11, 12 and 13. In this exemplary embodiment, the lens 42 is determined in its axial and radial position by three V-groove bearings.

The holding element 86g, which is also referred to as adjustable holding element 86g, has a defined spring stiffness in the radial direction. The spring stiffness is explained in more detail on the basis of the exemplary embodiment of FIG. 11.

The adjustable holding element 86g, which is fixedly connected to the actuator 88c, is moved in the radial direction by the actuator 88c. As a result, a prestress of the adjustable holding element is altered and the deformation of the lens 42 is thus obtained. In particular, a third-order bending of the optical element arises if all the holding elements 86e, 86f and 86g are situated in a plane which is perpendicular to the optical axis 40 and does not coincide with the plane of the optical element, in which no bending of the lens 42 is produced in the event of a radial force introduction.

Accordingly, the holding elements 86e, 86f and 86g are situated outside a so-called neutral axis, in which case, the further away the holding elements are from said neutral axis, the greater the third-order deformation of the optical element.

In this case, neutral axis denotes that part of the lens 42 which is not influenced in the event of a deformation by bending, to put it more precisely the length of which is not altered. Typically, the neutral axis is arranged in the centre of the lens 42, that is to say between object side and image side of the lens.

The forces for introducing the deformation into the lens 42 act directly on the holding element 86g, such that a short force flux is obtained. It is advantageous in this case that no substances such as adhesive or solder which tend towards creapage effects under loading are situated between holding element 86 and carrying ring 84.

In this case, the embodiment of the carrying ring with three holding elements 86e, 86f and 86g as shown in FIG. 9 can also be used as transport protection when transporting lenses, since an increase in the prestress force also increases the holding force with which the lens 42 is safeguarded against a mechanical loading during a transport process. After a transport process has been effected, the prestress can be reduced to a smaller value desired for the case of operation.

FIG. 10 shows a first exemplary embodiment of a holding element 86 in perspective plan view. The holding element 86 has a cutout 103, here a groove 104, having a first contact area 106 and a second contact area 108. In the groove 104, also called V-groove 104, the lens 42, not illustrated here, is mounted in such a way that the edge region 98 comes into contact with the first contact area 106 or the second contact area 108. A respective one of the edge regions, the object-side edge region 98a or the image-side edge region 98b, comes into contact with the first contact area 108 or the second contact area 106. The lens 42 is retained in the groove 104 in this way.

The circles 100 can be discerned, which realize, illustrated symbolically, the connection between holding element and carrying ring or actuator. The holding element 86 illustrated in FIG. 10 is provided for the exemplary embodiment, illustrated in FIG. 8, of the manipulator 60. A longitudinal extent 110 and an extent in the direction 112 perpendicular thereto are not the subject matter of the present disclosure, and modifications with regard to the length of the longitudinal extent 110 and the width of the extent 112 lie within the scope of the disclosure as long as the holding element has a region with the cutout 103, which corresponds to the V-groove 104 in this exemplary embodiment.

FIG. 11 illustrates a further exemplary embodiment of a holding element 86. The holding element 86 can be inserted into the manipulator 60 illustrated in FIG. 9 and is therefore referred to as holding element 86g. The holding element 86g has a V-groove-type cutout 103. The fixing devices illustrated as circles 100 can furthermore be discerned.

The holding element 86g furthermore has a slotted region 114 directed substantially perpendicular to the cutout 103. The defined spring stiffness in the radial direction of the lens 42 retained in the V-groove 104 is thereby obtained.

A bending beam clamped on two sides arises which can be freely resilient in the radial direction in the holding region. This spring action gives rise to a spring force with which the optical element, that is to say the lens 42, is pressed against the fixed holding elements 86f and 86e illustrated in the exemplary embodiment in FIG. 9 and is therefore determined in terms of its position. The lens 42 is therefore held under radial prestress.

In this case, the holding element 86g is an adjustable holding element, and it is fixedly connected to the actuator 88c, which can move the holding element 86g in the radial direction. As a result, the prestress of the adjustable holding element 86g is altered and, consequently, so is the deformation of the lens 42. An, in particular third-order, bending of the lens 42 can be effected if all the holding elements 86e, 86f and 86g are arranged in a plane which is perpendicular to the optical axis 40. Said plane cannot coincide with the plane of the lens in which no bending of the lens would be produced in the event of a radial force introduction. This means that the holding elements 86e, 86f and 86g have to be situated outside the so-called neutral axis. The further away the holding elements 86e, 86f and 86g are arranged from the neutral axis, the greater the third-order deformation of the lens and the greater the size, i.e. the magnitude, of the deformation.

A connection between the holding element 86g and the actuator 88c can be produced by a screw connection, for example, but this is not the subject matter of the disclosure. The actuator 86g can be embodied for example as a piezoelectric actuator or as an actuator operated by compressed air.

The actuator 88 can furthermore be incorporated into a closed-loop control circuit in order to be able to actively influence the third-order deformation. In this case, the actuator 88 is fixedly connected to the carrying ring. The closed-loop control circuit of each actuator 88 can be driven separately in this case.

The cutout 103 can also be embodied differently from the V-groove cutout, and the contact areas 106 and 108 can also be embodied as non-flat areas, as shown in the illustrations in FIG. 14. What is important is that the lens 42 is mounted in the V-groove 104, such that the contact area 108 is in contact with the edge region 98a of the lens 42 and the contact area 106 is in contact with the edge region 98b.

FIG. 12 shows a holding element 86 in which an optical element 42 is held. This is a sectional illustration parallel to the optical axis 40 of the holding element 86 shown in FIGS. 8 and 10. The holding element 86 has the cutout 103, configured as V-groove 104. In this case, the optical element 42 bears both on the first contact area 106 and on the second contact area 108 and is held in the V-groove 104 in this way.

FIG. 13 shows, in sectional illustration along the optical axis 40, the lens 42 and the holding element 86 and also an actuator 88 acting on the holding element 86. The cutout 103 has the first contact area 106 and also the second contact area 108, wherein these come into contact with the edge region 98a and the edge region 98b of the lens 42, wherein the cutout has a first curved area 116 and a second curved area 118 in addition to the first contact area 106.

This exemplary embodiment of the holding element 86 is arranged with respect to the lens 42 in such a way that the cutout 103 is situated outside the neutral axis 120 of the lens 42.

FIG. 14 shows various embodiments of the mounting of the optical element, that is to say the lens 42, in or with the holding element 86. In the illustrations 14a, 14b and 14c, the lens 42 in each case has a cutout 122, wherein the cutout 122 has different geometrical forms. The cutout 122 is a V-groove in FIG. 14a, the cutout 122 has a trapezoidal shape in FIG. 14b, and the cutout 122 has a rounded form in FIG. 14c.

What is common to all three cutouts 122 is that they form in each case a first contact area 106 and at least one second contact area 108. In this case, the holding element 86 is retained with a wedge element—referred to as lug 128—in the cutout 122. In FIGS. 14d, 14e, 14f, 14g and 14h, the holding element 86 has the cutout 103, wherein the lens is retained in the cutout 103. The statements made with regard to FIGS. 8 to 13 are applicable to this embodiment.

According to the disclosure, the cutouts 103 have in each case a first contact area 106 and a second contact area 108. In this case, the contact areas, as shown in FIGS. 14f to 14h, can also have curved geometrical areas. Said curved geometrical areas are designated by the reference numerals 130, 132, 134 and 136 and can have in each case a different degree of rounding, i.e. a different radius. In this case, a cutout 103 can also have two differently formed contact areas. The edge region 98a and 98b of the lens 42 is in each case formed in such a way that it comes into contact with the first contact area 106 and the second contact area 108 in a positively locking manner.

In this case, the disclosure also encompasses the fact that the respective contact area is embodied virtually in punctiform fashion.

FIG. 15 illustrates a further exemplary embodiment of the holding element 86 in a sectional illustration along the optical axis 40. The illustration likewise shows the actuator 88d, which acts on the holding element 86 at the location that can be discerned in FIG. 15. The cutout 103 having the first contact area 106 and the second contact area 108 can furthermore be discerned.

The actuator 88d and the holding element 86 are embodied in one piece or integrated into this. The holding element, designated as 86h here, has four solid-state articulations 140a, 140b, 140c and 140d, which enable a rectilinear movement of the holding region, designated by the reference numeral 142 here, in the radial direction. The radial direction is identified here by the arrow having the reference numeral 144.

FIG. 16 schematically shows the lens 42 retained in the holding element 86, to put it more precisely in the cutout 103 of the holding element 86. The actuator engages on the holding element via a stepping-up transmission gearing 146, wherein the holding element is mounted on the carrying ring 84 and the actuator 88 is mounted separately. The stepping-up transmission gearing 146 enables a high resolution of the deformation of the lens 42 since fine force inputs can be realized.

FIG. 17 shows a further embodiment of a manipulator 60 with the carrying ring 84, holding elements 86 and also an actuator 88 arranged parallel to the optical axis on the respective holding element 86. A force input designated by the arrow 148 onto the holding element 86 is realized by the actuator 88.

In this case, the direction parallel to the optical axis of a force input 147 is indicated only by way of example; according to the disclosure, the direction of the actuator 88d relative to the optical axis of the lens onto which the force input is realized by the actuator can be different from that of the actuator 88e.

The force input and/or the moment input can be chosen, with the embodiments shown in the figures above, from one of the parameters: intensity of the force input, direction of the force input relative to the local optical axis 40 of the optical element 42, intensity and direction of the moment input.

FIG. 18 shows the optical element 42 in sectional illustration along the optical axis 40. The optical element 42 is mounted by the manipulator 60.

In the embodiment illustrated in FIG. 18, the manipulator 60 has a carrying ring 148 and also a plurality of holding elements 150. In the embodiment shown in FIG. 18, each of the holding elements 150 has a first limb 152, which is connected to the carrying ring 148, and also a second limb 154, wherein the second limb 154 is connected to the lens 42. The connection can be a cohesive connection.

By virtue of the arrangement of a plurality of holding elements 150 in a manner distributed over the periphery of the carrying ring 148, it is possible to set both tilting movements of the lens 42 (or generally of an optical component) and higher-order deformations thereof, and also, given identical deflection of the holding elements 150, a pure z displacement in the direction of the optical axis.

In this embodiment of the manipulator 60, the holding elements 150 are actively adjustable, such that a tilting with respect to a plane perpendicular to the optical axis 40 and low- and higher-order astigmatic deformations can be input into the lens 42. The holding elements 150 are actively vertically adjustable by actuators, e.g. by piezoelectric elements. If more than eight holding elements 150 are provided, a higher-order deformation is made possible.

Realizing a pure z displacement, i.e. a displacement of the lens 42 in the direction of the optical axis 40, is furthermore made possible. Consequently, to summarize, a combination of z displacement, tilting and deformation of the lens is realized by the manipulator 60. In this case, it is essential to the disclosure that the holding elements 150 are actively adjustable holding elements, wherein the actuator which realizes the adjustment can be arranged both in holding element 150 and at the carrying ring 148.

In one embodiment, it is provided that the actuator acts on the carrying ring 148 and realizes a vertical adjustment of the holding elements 150 by the force and/or moment input. In another embodiment, it is provided that the actuator is integrated in the holding element 150 and e.g. the holding element 150 deforms.

A first measuring system, which can measure the force in the holding element 150, is furthermore provided, in a manner integrated in the manipulator. Provision is furthermore made for determining the position of the lens 42 relative to the carrying ring 148 by a second measuring system.

FIG. 19 shows a further embodiment of the manipulator 60 in a sectional illustration. FIG. 19 illustrates an exemplary embodiment of the manipulator principle in FIG. 18.

The manipulator 60 has a carrying ring 158 and also a holding element 160. It goes without saying that a plurality of holding elements 160, e.g. three or more, can be present in a manner distributed peripherally at the carrying ring 158. By virtue of the arrangement of a plurality of holding elements 160 in a manner distributed over the periphery of the carrying ring 158, both tilting movements of the optical element 42 and higher-order deformations thereof can be realized. Only one of the holding elements 160 is described below.

The holding element 160 has a first limb 164 and a second limb 166. In this case, the optical element, e.g. a lens 42, is mounted at the second limb 166. The lens 42, as illustrated, can bear on the second limb 166 at 167, or it can be fixed to an underside of the limb 166 by a cohesive connection. The holding element 160 can be displaced in the vertical direction, as illustrated by the arrow 168.

Both in the present exemplary embodiment and in the exemplary embodiment in accordance with FIG. 18, the respective holding element 160 and 150 can also have just a single limb, wherein the lens 42 is then fixed e.g. to one side of the limb, and the limb is then connected to the carrying ring in moveable fashion.

The holding element 160 is connected to the carrying ring 158 by a solid-state articulation 172. This connection by the solid-state articulation 172 enables a one-piece connection between the carrying ring 158 and the holding element 160, wherein the holding element 160 can be shifted relative to the carrying ring 158. A further solid-state articulation 173 can be present between the first and second limb 164, 166.

The solid-state articulation 172 has as location with reduced bending stiffness and is thereby demarcated from the adjacent zones, which are regarded as rigid bodies, here the carrying ring 158. The reduced bending stiffness is generally produced by a local cross-sectional reduction. In this case, the cross section can be reduced only along one or along both spatial directions. The cross-sectional alteration can have different geometrical forms. Optionally, the cross section has a continuous alteration, e.g. the tapering has the form of a circle arc. The solid-state articulation 172 has the property that a movement can be performed without play and without friction between the adjacent rigid bodies. On account of the elastic deformation, a relative movement between the two adjacent partners, that is to say the zone formerly referred to as rigid bodies, is realized. A force is involved for deflection of such an articulation. Said force is introduced by an actuator 180. The solid-state articulation 172 with circular excision realizes a stationary pivot. The actuator 180 is here for example an adjusting screw 181 having a fine thread, which screw is seated in a carrying ring section 158a and can be moved relative to the latter by e.g. a thread (arrow 182) and, at a distance from the solid-state articulation 172, presses against the limb 164 of the holding element 160 and correspondingly pivots the latter to a greater or lesser extent, whereby a force acts on the lens 42 at its peripheral location lying on the limb 166, which force can move and/or deform said lens.

A measuring system 184 is optionally provided, which can measure the position of the actuator 180 relative to the carrying ring 158, e.g. here relative to the carrying ring section 158a.

It is also possible that the manipulator according to the present disclosure combines in itself both kinds of manipulating a lens, namely deforming and positioning the lens. To this end, two basically different approaches are conceivable. In the first approach, the deformation and positioning functionalities are arranged in series one behind the other. The second approach is to perform deformation as well as positioning via a corresponding manipulator kinematics in parallel arrangement.

By this way, it is possible to combine several positioning operations and deformation operations in one system. In the serial approach, the deformation is carried out in the ‘inner’ system, wherein this inner system is then displaced and/or tilted as a whole.

1. A projection objective for microlithography, comprising a plurality of lenses which in each case have a local optical axis, wherein a first manipulator with a first actuator and at least one second actuator is assigned to at least one first lens from the plurality of lenses, and wherein a first force input and/or moment input can be realized by the first actuator and a second force input and/or moment input can be realized by the second actuator, wherein the first force input and/or moment input and the second force input and/or moment input differ with regard to at least one of the parameters: intensity of the force and/or moment input, direction of the force input relative to the local optical axis, direction of the moment input relative to a periphery of the first lens, such that different ratios of waviness of the lowest radial order to the next higher radial order on at least one surface of the first lens can be generated.

2. A projection objective for microlithography, comprising a plurality of lenses which in each case have a local optical axis, wherein a first manipulator with a first actuator and at least one second actuator is assigned to at least one first lens from the plurality of lenses, and wherein a first force input and/or moment input can be realized by the first actuator and a second force input and/or moment input can be realized by the second actuator, wherein the first force input and/or moment input and the second force input and/or moment input differ with regard to at least one of the parameters: intensity of the force and/or moment input, direction of the force input relative to the local optical axis, direction of the moment input relative to a periphery of the first lens, wherein at least one second lens having a local optical axis with a second manipulator is provided, wherein the second manipulator has a first and at least one second actuator, wherein a first force input and/or moment input can be realized by the first actuator and a second force input and/or moment input can be realized by the second actuator, wherein the first force input and/or moment input and the second force input and/or moment input differ with regard to at least one of the parameters: intensity of the force and/or moment input, direction of the force input relative to the local optical axis, direction of the moment input relative to a periphery of the first lens.

3. The projection objective of claim 1, wherein the first moment input can be realized tangentially with respect to the periphery of the first lens.

4. The projection objective of claim 2, wherein the second moment input can be realized radially.

5. The projection objective of claim 1, wherein the first and the second actuator are arranged peripherally at the first lens and in a manner offset by 180°.

6. The projection objective of claim 1, wherein a third actuator is provided, which is arranged peripherally at the first lens.

7. The projection objective of claim 6, wherein a fourth actuator is provided, which is arranged peripherally at the first lens.

8. The projection objective of claim 7, wherein the third actuator and the fourth actuator are arranged in a manner offset by 180°.

9. The projection objective of claim 6, wherein further actuators are provided, which are in each case arranged peripherally at the first lens, wherein the actuators realize at least two different force inputs and/or moment inputs at the first lens, wherein the force inputs are selected from a group of forces comprising forces which have different angles with the local optical axis, and the moment inputs are selected from a group of moments comprising radial or tangential moments.

10. The projection objective of claim 7, wherein further actuators are provided, which are in each case arranged peripherally at the first lens, wherein the actuators realize at least two different force inputs and/or moment inputs at the first lens, wherein the force inputs are selected from a group of forces comprising forces which have different angles with the local optical axis, and the moment inputs are selected from a group of moments comprising radial or tangential moments.

11. The projection objective of claim 1, wherein each of the actuators of the manipulator of the first lens has an open-loop and/or closed-loop control circuit.

12. The projection objective of claim 2, wherein each of the actuators of the manipulator of the first lens has an open loop and/or closed loop control circuit.

13. The projection objective of claim 1, wherein an aberration of the projection objective as a result of thermal heating and/or material alteration of one or more of the lenses from the plurality of lenses can be compensated for by the complex deformation of the first lens.

14. The projection objective of claim 2, wherein an aberration of the projection objective as a result of thermal heating and/or material alteration of one or more of the lenses from the plurality of lenses can be compensated for by the complex deformation of the first lens.

15. The projection objective of claim 1, wherein each actuator has a first actuator element and a second actuator element, wherein the first actuator element is arranged on the image side at the first lens and/or second lens and the second actuator element is arranged on the object side with respect to the first lens and/or second lens.

16. The projection objective of claim 2, wherein each actuator has a first actuator element and a second actuator element, wherein the first actuator element is arranged on the image side at the first lens and/or second lens and the second actuator element is arranged on the object side with respect to the first lens and/or second lens.

17. The projection objective of claim 1, wherein each actuator element can be moved pneumatically.

18. The projection objective of claim 2, wherein each actuator element can be moved pneumatically.

19. The projection objective of claim 1,wherein each actuator element can be moved hydraulically, mechanically and/or electrically and/or magnetically and/or piezoelectrically.

20. The projection objective of claim 2, wherein each actuator element can be moved hydraulically, mechanically and/or electrically and/or magnetically and/or piezoelectrically.
